(19) United States
(12) Patent Application Publication
(10) Pub. No.: US 2026/0251464 A1
(43) Pub. Date: Aug. 27, 2026

(54) SYSTEM

(71) Applicant: SoftBank Group Corp., Tokyo (JP)

(72) Inventor: Emi KATAGIRI, Tokyo (JP)

(73) Assignee: SoftBank Group Corp., Tokyo (JP)

(21) Appl. No.: 19/539,062

(22) Filed: Feb. 13, 2026

(30) Foreign Application Priority Data
Feb. 21, 2025 (JP) 2025-027044

(51) Int. Cl. G01C 21/34; G01C 21/36; G06V 10/82; G06V 40/16

(52) U.S. Cl. CPC G01C 21/3415; G01C 21/3446; G01C 21/3492; G01C 21/3617; G06V 10/82; G06V 40/174

(57) ABSTRACT

The system according to the embodiment comprises a reception unit, a generation unit, and a navigation unit. The reception unit receives input of a destination. The generation unit calculates a route from a current location to the destination based on information received by the reception unit. The navigation unit displays the route in cooperation with building and floor guides based on the route generated by the generation unit.

### CROSS-REFERENCE TO RELATED APPLICATION

The present application claims priority to and incorporates by reference the entire contents of Japanese Patent Application No. 2025-027044 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, map applications provide insufficient guidance inside buildings or to detailed destinations, which may cause users to get lost.

### SUMMARY OF THE INVENTION

The system according to the embodiment comprises a reception unit, a generation unit, and a navigation unit. The reception unit receives input of a destination. The generation unit calculates a route from a current location to the destination based on information received by the reception unit. The navigation unit displays the route in cooperation with building and floor guides based on the route generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

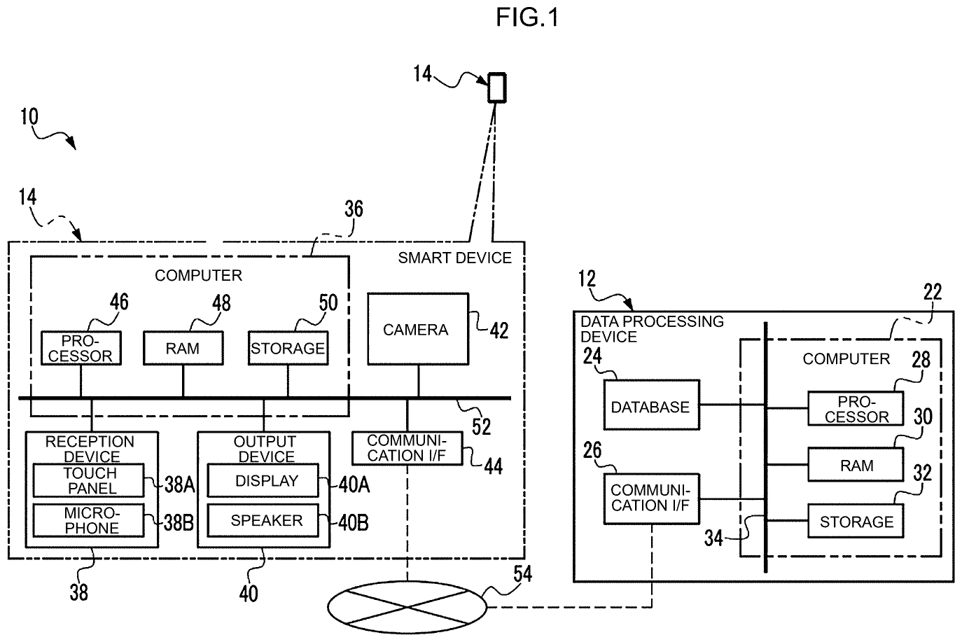

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

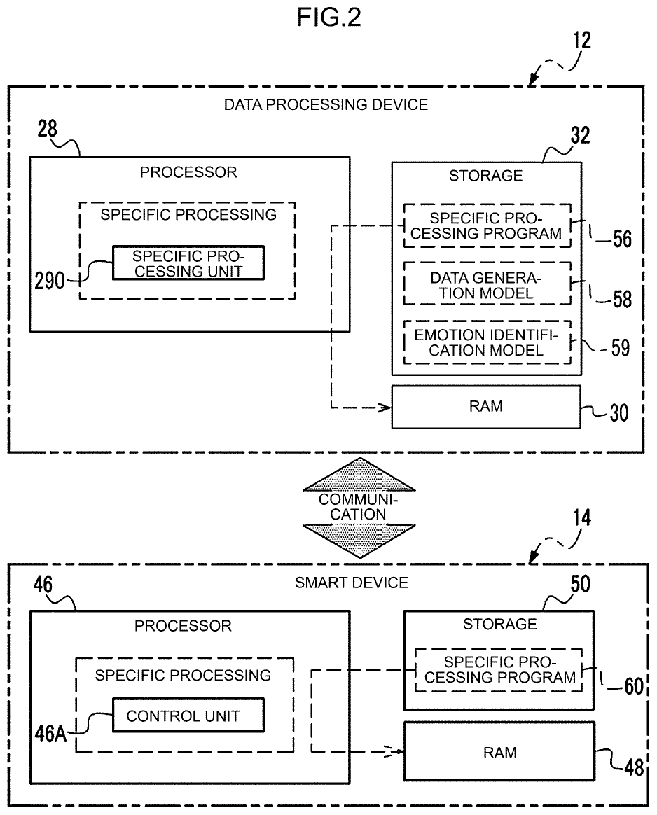

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The navigation system according to the embodiment of the present invention is a system that, when a user inputs a destination, not only displays a route from the current location to the destination on a map application, but also guides the user to the true destination in cooperation with guides inside the building and floor guides. This navigation system enables the user to reach the destination without wandering inside the building. For example, when the user inputs a specific destination such as ‘Conference room on the 3rd floor of XX Building,’ the map application displays a route from the building entrance to the conference room on the 3rd floor. Furthermore, the map application works in conjunction with guides inside the building and floor guides to guide the user to the true destination. For example, it displays the floor guide inside the building and indicates the locations of elevators and stairs. In addition, it displays a detailed route to the destination based on the floor guide. As a result, the user can reach the destination without wandering inside the building. This mechanism eliminates the inconvenience of map applications and enables the user to be smoothly guided to the true destination. For example, since the route to specific destinations such as conference rooms or stores inside the building is displayed, the user can reach the destination without getting lost. Thus, the navigation system enables the user to reach the destination without wandering inside the building. Specifically, the navigation system receives destination information input by the user (e.g., text ‘3rd floor conference room,’ voice ‘I want to go to the conference room on the 3rd floor,’ etc.) at the reception unit, and the reception unit converts the input data into structured data (e.g., attribute vectors such as building ID, floor number, room number) using a natural language processing module. The system acquires current location information (e.g., GPS coordinates, Wi-Fi trilateration results, beacon ID, etc. as multidimensional vectors) and inputs these into a route generation AI module. The route generation AI, for example, uses a graph neural network or reinforcement learning algorithm to search for the optimal route on a high-dimensional graph structure consisting of nodes (rooms, elevators, stairs, etc.) and edges (corridors, stair routes, etc.) inside the building. Examples of input to the AI include (1) user's current location vector (e.g., x=35.6895, y=139.6917, floor=1), (2) destination attribute vector (e.g., building_id=123, floor=3, room=305), and (3) obstacle/congestion condition tensor inside the building (e.g., congestion scalar value for each node). The AI output includes node sequences (e.g., entrance→elevator→3rd floor→conference room 305), movement instructions for each route segment (e.g., ‘go straight to the elevator,’ ‘turn right on the 3rd floor,’ etc. as text sequences), or detailed route coordinate sequences (e.g., coordinate lists for each segment). Examples of output include (1) navigation instruction sequences such as ‘go straight 20 m from the entrance to the elevator, turn right on the 3rd floor to conference room 305,’ (2) estimated total travel time for the route (e.g., 5 minutes), and (3) alternative route candidate lists for congestion avoidance. In subsequent processing, the navigation unit overlays the route on the floor guide image on the user interface based on the AI output and highlights the locations of elevators and stairs. Furthermore, if the user's current position changes, the system re-inputs the data to the AI in real time and dynamically recalculates the route. Unlike conventional human guidance or static map display, this system uses computer-specific unconventional methods such as dynamic route search on high-dimensional graphs and real-time reflection of congestion conditions, greatly improving processing speed and guidance accuracy. Technical effects include enabling users to reach their destination by the shortest and most comfortable route without getting lost in complex buildings, and providing flexible route guidance that reflects congestion and obstacle information. Application fields include navigation inside large buildings such as office buildings, commercial facilities, hospitals, airports, university campuses, support for visually impaired persons, and evacuation guidance during disasters.

The navigation system according to the embodiment comprises a reception unit, a generation unit, and a navigation unit. The reception unit receives input of a destination from the user. For example, the reception unit can receive destination input by methods such as text input, voice input, or touch input. The generation unit calculates a route from the current location to the destination based on information received by the reception unit. For example, the generation unit acquires the current location using GPS, Wi-Fi location information, beacons, etc., and calculates the route using algorithms such as shortest distance, shortest time, or congestion avoidance. The navigation unit displays a detailed route in cooperation with guides inside the building and floor guides based on the route generated by the generation unit. For example, the navigation unit displays the floor guide inside the building and indicates the locations of elevators and stairs. In addition, the navigation unit displays a detailed route to the destination based on the floor guide. As a result, the user can reach the destination without wandering inside the building. Some or all of the above-described processing in the navigation unit may be performed using AI, or may be performed without using AI. For example, the navigation unit may input floor guide information inside the building to a generation AI, and the generation AI can generate a detailed route. Thus, the navigation system enables the user to reach the destination without wandering inside the building. Specifically, the navigation system inputs destination information received from the user by the reception unit (e.g., text ‘3rd floor conference room,’ voice ‘I want to go to the conference room on the 3rd floor,’ etc.) to a natural language processing module, which converts the input data into structured data (e.g., attribute vectors such as building ID, floor number, room number). The system acquires current location information (e.g., GPS coordinate vector, Wi-Fi trilateration result vector, beacon ID vector, etc.) by the generation unit and inputs these multidimensional vector data to a route generation AI module. The route generation AI module, for example, uses a graph neural network or reinforcement learning algorithm to search for the optimal route on a high-dimensional graph structure consisting of nodes (rooms, elevators, stairs, etc.) and edges (corridors, stair routes, etc.) inside the building. Examples of input to the AI include (1) user's current location vector (e.g., x=35.6895, y=139.6917, floor=1), (2) destination attribute vector (e.g., building_id=123, floor=3, room=305), and (3) obstacle/congestion condition tensor inside the building (e.g., congestion scalar value for each node). The AI output includes node sequences (e.g., entrance→elevator→3rd floor →conference room 305), movement instructions for each route segment (e.g., ‘go straight to the elevator,’ ‘turn right on the 3rd floor,’ etc. as text sequences), or detailed route coordinate sequences (e.g., coordinate lists for each segment). Examples of output include (1) navigation instruction sequences such as ‘go straight 20 m from the entrance to the elevator, turn right on the 3rd floor to conference room 305,’ (2) estimated total travel time for the route (e.g., 5 minutes), and (3) alternative route candidate lists for congestion avoidance. The navigation unit overlays the route on the floor guide image on the user interface based on the AI output and highlights the locations of elevators and stairs. Furthermore, if the user's current position changes, the system re-inputs the data to the AI in real time and dynamically recalculates the route. Unlike conventional human guidance or static map display, this system uses computer-specific unconventional methods such as dynamic route search on high-dimensional graphs and real-time reflection of congestion conditions, greatly improving processing speed and guidance accuracy. Technical effects include enabling users to reach their destination by the shortest and most comfortable route without getting lost in complex buildings, and providing flexible route guidance that reflects congestion and obstacle information. Application fields include navigation inside large buildings such as office buildings, commercial facilities, hospitals, airports, university campuses, support for visually impaired persons, and evacuation guidance during disasters.

The navigation unit can track the user's position in real time and dynamically update the route. The navigation unit, for example, uses GPS, Wi-Fi location information, sensors, etc. to track the user's position in real time. For example, the navigation unit acquires the user's position using GPS and updates it in real time. The navigation unit can also track the user's position using Wi-Fi location information. Furthermore, the navigation unit can track the user's position using sensors. For example, the navigation unit acquires location information using sensors installed in the user's smartphone. As a result, the navigation unit can track the user's position in real time and dynamically update the route. Some or all of the above-described processing in the navigation unit may be performed using AI, or may be performed without using AI. For example, the navigation unit may input the user's location information to a generation AI, and the generation AI can dynamically update the route. Thus, the navigation system can provide more accurate navigation by dynamically updating the route according to the user's position. Specifically, the navigation unit receives location information data acquired from the user terminal (e.g., GPS coordinate vector [x=35.6895, y=139.6917, floor=2], Wi-Fi trilateration vector [AP1 strength, AP2 strength, AP3strength], acceleration/gyro sensor values [ax, ay, az, gx, gy, gz], etc.) as a time series array in real time. The navigation unit performs preprocessing such as noise removal, outlier correction, and coordinate transformation on these multidimensional vector data using a preprocessing module, and sequentially inputs them to a route generation AI module. The route generation AI module, for example, uses a recurrent neural network specialized for time series data processing or an autoregressive transformer model to estimate the user's movement tendencies and speed changes, and sequentially recalculates the optimal route from the current location to the destination. Examples of input to the AI include (1) current location vector [x=35.6895, y=139.6917, floor=2], (2) movement trajectory tensor for the past 10 seconds (10×3 dimensions), and (3) current movement speed scalar value (e.g., 1.2 m/s). The AI output includes (1) latest estimated current location vector, (2) estimated movement direction vector, (3) recalculated route node sequence (e.g., current location→elevator→3rd floor→conference room 305), and (4) movement instruction text sequence for each segment (e.g., ‘go straight 10 m,’ ‘turn right,’ etc.). Examples of output include (1) navigation instructions such as ‘go straight 15m from the current location to the elevator, turn right on the 3rd floor to conference room 305,’ (2) estimated total travel time for the route (e.g., 4 minutes 30 seconds), and (3) estimated arrival time according to the user's movement speed (e.g., arrival at 13:05). The navigation unit overlays the latest route on the floor guide image on the user interface based on these AI outputs and moves the user's current location marker in real time. Furthermore, if the user's movement speed or direction changes significantly, a threshold judgment module triggers re-input to the AI and immediately recalculates the route. Unlike conventional human guidance or static map display, this system uses computer-specific unconventional methods such as dynamic route search using high-dimensional time series data, real-time position estimation, and automatic learning of movement tendencies, greatly improving guidance accuracy and tracking performance. Technical effects include the ability to always present the latest optimal route immediately even if the user changes course or gets lost while moving in a complex building, and the ability to flexibly follow changes in movement speed and direction. Application fields include navigation inside large buildings such as office buildings, commercial facilities, hospitals, airports, university campuses, support for visually impaired persons, evacuation guidance during disasters, and route control for robots and autonomous mobile entities.

The navigation unit can grasp congestion conditions inside the building and propose a route that avoids congestion. The navigation unit, for example, uses sensor information, user location information, camera images, etc. to grasp congestion conditions inside the building. For example, the navigation unit acquires information from sensors installed inside the building to grasp congestion conditions. The navigation unit can also grasp congestion conditions based on user location information. Furthermore, the navigation unit can analyze camera images to grasp congestion conditions. For example, the navigation unit analyzes camera images inside the building in real time to grasp congestion conditions. As a result, the navigation unit can propose a route that avoids congestion. Some or all of the above-described processing in the navigation unit may be performed using AI, or may be performed without using AI. For example, the navigation unit may input congestion condition data to a generation AI, and the generation AI can propose a route that avoids congestion. Thus, the navigation system can enable users to move smoothly by proposing routes that avoid congestion. Specifically, the navigation unit integrally acquires congestion data collected from various sensors installed inside the building (e.g., infrared people counters, door open/close sensors, CO2 concentration sensors, etc.), such as the number of people per node (scalar value), passage counts per corridor, CO2 concentration per area, user location vector groups from user terminals (e.g., current location coordinate lists of multiple users), and image data from surveillance cameras inside the building (e.g., 640×480 pixel RGB images) as time series tensors. The navigation unit performs processing such as normalization, missing value completion, and image feature extraction (e.g., person counting by object detection CNN) on these diverse data using a preprocessing module and inputs them to a congestion estimation AI module. The congestion estimation AI uses, for example, a hybrid model combining convolutional neural networks and graph neural networks to integrate image features, sensor values, and location vectors in high-dimensional space and outputs congestion scalar values (e.g., congestion score from 0.0 to 1.0) for each node/area. Examples of input to the AI include (1) people count vector for each node (e.g., node A=12 people, node B=3 people), (2) person count tensor extracted from camera images (e.g., people map for each area), and (3) user location distribution heatmap (e.g., 100×100 grid). The AI output includes (1) congestion score array for each route node, (2) route cost map based on congestion, and (3) optimal route node sequence considering congestion avoidance (e.g., current location→less crowded corridor→elevator→destination). Examples of output include (1) navigation instructions such as ‘go through the less crowded corridor from the current location to the elevator and to the 3rd floor,’ (2) congestion heatmap image, and (3) estimated travel time for the congestion avoidance route (e.g., 5 minutes 30 seconds). The navigation unit displays congestion levels in color and highlights congestion avoidance routes on the user interface based on these AI outputs. Furthermore, if the congestion level exceeds a threshold, alternative route candidates are automatically presented. Unlike conventional human guidance or static map display, this system uses computer-specific unconventional methods such as real-time congestion estimation by integrating high-dimensional sensor, image, and location data, and congestion avoidance route search on graph structures, greatly improving guidance accuracy and movement efficiency. Technical effects include enabling users to avoid congestion and traffic jams and reach their destination comfortably and quickly, and providing flexible route guidance that responds immediately to changes in congestion conditions. Application fields include navigation inside large buildings such as office buildings, commercial facilities, hospitals, airports, university campuses, crowd control at event venues, and evacuation guidance during disasters.

The navigation unit can display floor guide information and indicate the locations of elevators and stairs. The navigation unit, for example, displays detailed floor guide information. For example, the navigation unit displays the layout of facilities inside the building, route guidance, equipment information, etc. The navigation unit can also indicate the locations of elevators and stairs. For example, the navigation unit displays the locations of elevators and stairs on the floor map. In addition, the navigation unit can indicate the locations of elevators and stairs using voice guidance. As a result, the navigation unit can display detailed floor guide information and indicate the locations of elevators and stairs. Some or all of the above-described processing in the navigation unit may be performed using AI, or may be performed without using AI. For example, the navigation unit may input floor guide information to a generation AI, and the generation AI can indicate the locations of elevators and stairs. Thus, the navigation system makes it easier for users to reach their destination by displaying detailed floor guide information. Specifically, the navigation unit receives floor guide information acquired from building management systems or blueprint databases (e.g., layout data for each floor, coordinate lists of rooms and equipment, attribute vectors for equipment such as elevators, stairs, toilets, etc.) as structured data. The navigation unit performs processing such as coordinate normalization, equipment attribute extraction, and labeling on these data using a preprocessing module and inputs them to a floor guide generation AI module. The floor guide generation AI uses, for example, image generation neural networks (e.g., U-Net or diffusion models) or text generation AI (large language models) to generate overlay images for highlighting the locations of elevators and stairs on the floor map image according to the user's current location, destination, and route, as well as guidance text and voice scripts. Examples of input to the AI include (1) floor layout coordinate list (e.g., x, y coordinates of each room and equipment), (2) user's current location and destination vectors, and (3) route node sequence (e.g., current location→elevator→3rd floor→conference room 305). The AI output includes (1) route overlay image to be superimposed on the floor map image, (2) coordinate list of highlight markers indicating the locations of elevators and stairs, (03) guidance text sequence such as ‘The elevator is at the far right,’ and (4) script data for voice synthesis. Examples of output include (1) floor guide image with route and equipment markers displayed on the user interface, (2) voice guidance such as ‘The elevator is 10 m ahead on the right from your current location,’ and (3) equipment information pop-ups (e.g., elevator capacity and operation status). The navigation unit dynamically generates and displays floor guide images on the user interface based on these AI outputs, and automatically switches highlight markers and voice guidance according to the user's current location and route. Furthermore, for users with visual impairments or elderly users, barrier-free functions such as voice guidance and enlarged display can be combined. Unlike conventional static floor maps or oral guidance by humans, this system realizes dynamic and individually optimized floor guide display by combining structured data and AI generation technology, greatly improving guidance accuracy and usability. Technical effects include enabling users to intuitively and quickly grasp the locations of equipment in complex buildings, and providing diverse guidance means in both visual and auditory aspects. Application fields include navigation inside large buildings such as office buildings, commercial facilities, hospitals, airports, university campuses, barrier-free support, and evacuation guidance during disasters.

The navigation system comprises a provision unit, and the provision unit can send a notification when the user reaches the destination. The provision unit, for example, sends a notification when the user reaches the destination. For example, the provision unit can send notifications by methods such as text messages, push notifications, or voice notifications. As a result, the provision unit can notify that the user has reached the destination. Some or all of the above-described processing in the provision unit may be performed using AI, or may be performed without using AI. For example, the provision unit may input the user's location information to a generation AI, and the generation AI can detect arrival at the destination and send a notification. Thus, the navigation system can confirm arrival at the destination by notifying the user when the destination is reached. Specifically, the provision unit inputs the user's current location vector (e.g., x=35.6895, y=139.6917, floor=3) and movement history tensor (e.g., location coordinate sequence for the past 30 seconds) sequentially received from the navigation unit, as well as the destination attribute vector (e.g., building_id=123, floor=3, room=305) to an arrival judgment module. The provision unit applies algorithms such as Euclidean distance between the user's current location and the destination, floor match judgment, and arrival threshold (e.g., within 2 m) judgment based on these data to automatically determine arrival at the destination. When using AI, time series location data and movement speed/direction vectors are input, and a recurrent neural network outputs an ‘arrival state’ label (e.g., 0=not arrived, 1=arrived) or arrival probability score (e.g., 0.98). Examples of input to the AI include (1) current location vector [x=35.6895, y=139.6917, floor=3], (2) destination vector [building_id=123, floor=3, room=305], and (3) movement trajectory tensor for the past 10 seconds (10×3 dimensions). The AI output includes (1) arrival judgment label (e.g., 1=arrived), (2) arrival probability score (e.g., 0.99), and (3) estimated arrival time (e.g., 13:05:12). Examples of output include (1) text notification such as ‘You have arrived at your destination,’ (2) push notification to the smartphone, and (3) arrival guidance by voice synthesis (e.g., ‘You have arrived at your destination’). The provision unit selects the optimal notification method (e.g., text, voice, vibration, etc.) for the user terminal based on these AI outputs and judgment results and immediately sends the notification. Furthermore, additional information related to the destination (e.g., meeting start time, store information, etc.) can be automatically displayed simultaneously with the arrival notification. Unlike conventional manual arrival confirmation and notification by humans, this system uses computer-specific unconventional methods such as high-precision location estimation, automatic arrival judgment, and automatic selection of multimodal notification methods, greatly improving the reliability of arrival confirmation and user experience. Technical effects include enabling users to reliably grasp arrival at the destination and providing immediate and appropriate information at the time of arrival. Application fields include navigation inside large buildings such as office buildings, commercial facilities, hospitals, airports, university campuses, support for visually impaired persons, and arrival management for logistics robots.

The reception unit can estimate the user's emotion and adjust the method of destination input based on the estimated emotion. The reception unit, for example, estimates the user's emotion. For example, the reception unit estimates the user's emotion using methods such as facial expression recognition, voice analysis, and behavioral pattern analysis. In addition, the reception unit adjusts the method of destination input based on the estimated emotion. For example, if the user is feeling stressed, the reception unit provides a simple interface and minimizes the input steps. If the user is relaxed, the reception unit provides detailed input options and can propose customizable input methods. Furthermore, if the user is in a hurry, the reception unit prioritizes voice input to enable quick destination input. As a result, the reception unit improves user convenience by adjusting the input method according to the user's emotion. Emotion estimation is realized using, for example, an emotion engine or a generation AI with emotion estimation functions. The generation AI may be a text generation AI (e.g., LLM) or a multimodal generation AI, but is not limited to these examples. Some or all of the above-described processing in the reception unit may be performed using AI, or may be performed without using AI. For example, the reception unit may input the user's emotion data to a generation AI, and the generation AI can adjust the input method. Thus, the navigation system improves user convenience by adjusting the input method according to the user's emotion. Specifically, the reception unit inputs face image tensors acquired from the user terminal's camera (e.g., 224×224 pixel RGB images), voice waveform data acquired from the microphone (e.g., 1 second of audio sampled at 16 kHz), and behavioral log vectors such as touch operations and movement speed (e.g., tap interval, input speed, walking speed, etc.) to an emotion estimation AI module. The emotion estimation AI, for example, extracts facial expression features from face images using a convolutional neural network, analyzes voice tone and speech rate using a recurrent neural network for voice recognition, and analyzes behavioral patterns using a time series model (e.g., LSTM). Examples of input to the AI include (1) face image tensor (e.g., images of smiling, angry, or expressionless faces), (2) voice waveform (e.g., utterances such as ‘I'm in a hurry,’ ‘I want to input slowly’), and (3) touch operation log (e.g., continuous taps, long presses, etc.). The AI output includes (1) emotion label (e.g., stress, relaxation, hurry), (2) emotion intensity score (e.g., stress level 0.85), and (3) recommended input mode (e.g., simple UI, detailed UI, voice priority). Examples of output include (1) ‘Voice input is recommended due to high stress level,’ (2) ‘Detailed options are displayed due to relaxed state,’ and (3) ‘Shortest procedure UI is displayed due to hurry state.’ The reception unit immediately switches the layout and input procedure of the user interface based on these AI outputs. For example, if the stress level is high, the number of buttons is reduced and the voice input button is highlighted; if the user is relaxed, detailed customization items are expanded. Furthermore, if the user's emotional state changes, a threshold judgment module triggers AI re-estimation and dynamically reconfigures the UI. Unlike conventional uniform input interfaces, the reception unit integrates high-precision emotion estimation using multimodal data and real-time UI optimization to realize an input experience that responds to the user's psychological state and usage situation. Technical effects include reducing user stress and input errors, shortening the time required to complete input, and flexibly responding to diverse user attributes and usage scenes. Application fields include building navigation reception terminals, guidance systems for public facilities, reception support for medical institutions, and interface optimization for visually and hearing impaired persons.

The reception unit can analyze the user's past destination input history and propose an optimal input method. The reception unit, for example, analyzes the user's past destination input history. For example, the reception unit automatically displays destinations that the user has frequently input in the past as candidates. In addition, the reception unit can preferentially propose input methods (voice, text, etc.) that the user has used in the past. Furthermore, the reception unit can predict and propose destinations used at specific times based on the user's past input history. As a result, the reception unit can propose an optimal input method to the user by analyzing past input history. Some or all of the above-described processing in the reception unit may be performed using AI, or may be performed without using AI. For example, the reception unit may input the user's past input history data to a generation AI, and the generation AI can propose an optimal input method. Thus, the navigation system can propose an optimal input method to the user by analyzing past input history. Specifically, the reception unit inputs a destination input history database recorded in time series for each user (e.g., structured table of destination IDs, input date and time, input method type, input time required, etc. for the past year) to an analysis AI module. The analysis AI, for example, uses a time series clustering algorithm or an autoregressive neural network to extract the user's input tendencies and destination patterns by time of day. Examples of input to the AI include (1) destination ID sequence for the past 30 times (e.g., conference room 305, cafe A, store B, etc.), (2) input method label sequence for each time (e.g., voice, text, touch), and (3) input date and time vector (e.g., 2024-06-01 09:00, etc.). The AI output includes (1) frequently used destination candidate list (e.g., conference room 305, cafe A), (2) recommended input method (e.g., voice input in the morning on weekdays, text input in the afternoon on holidays), and (3) destination prediction list by time of day (e.g., conference room 305 on Monday morning, cafe A on Friday night). Examples of output include (1) ‘Display conference room 305 as a candidate, used 8 out of the last 10 times,’ (2) ‘Recommend voice input in the morning,’ and (3) ‘Automatically display cafe A as a candidate on Friday night.’ The reception unit automatically displays candidate destinations and highlights recommended input methods on the user interface based on these AI outputs. Furthermore, as new input history is accumulated for the user, the AI model continuously improves personalization accuracy through online learning. Unlike conventional static candidate display or uniform input method presentation, the reception unit analyzes history patterns for each user in high-dimensional vector space and provides a real-time optimized input experience. Technical effects include shortening input procedures, reducing input errors, and improving user satisfaction. Application fields include building navigation reception terminals, guidance systems for public facilities, reception support for medical institutions, and optimization of services for repeat users.

The reception unit can present input candidates based on the user's current situation and areas of interest when inputting a destination. The reception unit, for example, presents input candidates based on the user's current situation and areas of interest. For example, the reception unit presents popular spots near the user's current location as candidates. In addition, the reception unit can propose related destinations based on the user's areas of interest (restaurants, shopping, etc.). Furthermore, the reception unit can present optimal destinations according to the user's current situation (time of day, weather, etc.). As a result, the reception unit makes destination input easier by presenting input candidates based on the user's situation and areas of interest. Some or all of the above-described processing in the reception unit may be performed using AI, or may be performed without using AI. For example, the reception unit may input data on the user's current situation and areas of interest to a generation AI, and the generation AI can present input candidates. Thus, the navigation system makes destination input easier by presenting input candidates based on the user's situation and areas of interest. Specifically, the reception unit inputs the current location vector acquired from the user terminal (e.g., x=35.6895, y=139.6917, floor=2), current time, day of the week, weather information (e.g., 2024-06-01 12:00, sunny), and areas of interest vector recorded in the user profile (e.g., restaurant=0.8, shopping=0.6, sightseeing=0.4, etc.) to an input candidate generation AI module. The input candidate generation AI, for example, uses a graph neural network or a large language model to match the spot information database near the current location and the user interest vector in high-dimensional space and generates a destination candidate list optimized for the situation and interest. Examples of input to the AI include (1) current location vector [x=35.6895, y=139.6917, floor=2], (2) areas of interest vector [restaurant=0.8, shopping=0.6], and (3) weather and time information [sunny, 12:00]. The AI output includes (1) candidate destination list (e.g., nearby restaurant A, cafe B, shop C), (2) recommendation score for each candidate (e.g., restaurant A=0.92), and (3) explanation text for each candidate (e.g., ‘Terrace seats are popular today because it is sunny’). Examples of output include (1) ‘Display restaurant A 50 m ahead from the current location as a candidate,’ and (2) ‘Shopping mall B is having a sale today.’ The reception unit dynamically displays the candidate list on the user interface and automatically adjusts the order and explanation text according to the user's situation and interests based on these AI outputs. Furthermore, if the user's areas of interest or weather/time change, the AI model performs re-inference and immediately updates the candidate list. Unlike conventional static candidate presentation, the reception unit realizes dynamic candidate generation by integrating multidimensional situation data and user profiles, greatly improving the efficiency and satisfaction of destination input. Technical effects include shortening input procedures and optimizing destination selection by presenting candidates that respond to the user's situation and preferences. Application fields include building navigation reception terminals, guidance systems for commercial facilities, tourist information centers, and personalized service provision.

The reception unit can estimate the user's emotion and determine the priority of input candidates based on the estimated emotion. The reception unit, for example, estimates the user's emotion. For example, the reception unit estimates the user's emotion using methods such as facial expression recognition, voice analysis, and behavioral pattern analysis. In addition, the reception unit determines the priority of input candidates based on the estimated emotion. For example, if the user is tired, the reception unit prioritizes nearby rest spots. If the user is excited, the reception unit can prioritize entertainment facilities. Furthermore, if the user is relaxed, the reception unit can prioritize places where the user can relax, such as cafes or parks. As a result, the reception unit improves user convenience by determining the priority of input candidates according to the user's emotion. Emotion estimation is realized using, for example, an emotion engine or a generation AI with emotion estimation functions. The generation AI may be a text generation AI (e.g., LLM) or a multimodal generation AI, but is not limited to these examples. Some or all of the above-described processing in the reception unit may be performed using AI, or may be performed without using AI. For example, the reception unit may input the user's emotion data to a generation AI, and the generation AI can determine the priority of input candidates. Thus, the navigation system improves user convenience by determining the priority of input candidates according to the user's emotion. Specifically, the reception unit inputs face image tensors acquired from the user terminal's camera (e.g., 224×224 pixel RGB images), voice waveform data (e.g., 1 second of audio), and touch operation logs (e.g., input speed, tap interval, etc.) to an emotion estimation AI module. The emotion estimation AI extracts facial expression features using a convolutional neural network, analyzes voice tone and speech rate using a recurrent neural network for voice recognition, and analyzes behavioral patterns using a time series model. Examples of input to the AI include (1) face image tensor (e.g., facial expressions of fatigue, excitement, relaxation), (2) voice waveform (e.g., utterances such as ‘I'm tired,’ ‘I'm looking forward to it’), and (3) touch operation log (e.g., continuous taps, long presses, etc.). The AI output includes (1) emotion label (e.g., fatigue, excitement, relaxation), (2) emotion intensity score (e.g., fatigue level 0.9), and (3) input candidate priority list (e.g., rest spot ranked first, entertainment ranked second, cafe ranked third). Examples of output include (1) ‘Display rest spot at the top due to high fatigue level,’ (2) ‘Prioritize entertainment facilities due to excitement,’ and (3) ‘Display cafes and parks at the top due to relaxation.’ The reception unit dynamically adjusts the order of the candidate list and highlights candidates that match the user's emotional state on the user interface based on these AI outputs. Furthermore, if the emotional state changes, the AI model performs re-inference and immediately updates the candidate order. Unlike conventional uniform candidate presentation, the reception unit realizes an input experience that responds to the user's psychological state by combining multimodal emotion estimation and candidate order optimization. Technical effects include improving the efficiency of destination selection, increasing user satisfaction, and reducing incorrect selections. Application fields include building navigation reception terminals, guidance systems for public facilities, reception support for medical institutions, and optimization of barrier-free interfaces.

The reception unit can preferentially present highly relevant candidates by considering the user's geographic location information when inputting a destination. The reception unit, for example, presents highly relevant candidates by considering the user's geographic location information. For example, the reception unit prioritizes candidates that are close to the user's current location. In addition, the reception unit can present related spots near places the user has visited in the past. Furthermore, the reception unit can present optimal candidates by considering the travel time from the user's current location. As a result, the reception unit can present highly relevant candidates by considering the user's geographic location information. Some or all of the above-described processing in the reception unit may be performed using AI, or may be performed without using AI. For example, the reception unit may input the user's geographic location information to a generation AI, and the generation AI can present highly relevant candidates. Thus, the navigation system can present highly relevant candidates by considering the user's geographic location information. Specifically, the reception unit inputs the current location vector acquired from the user terminal (e.g., x=35.6895, y=139.6917, floor=3), past visit history vector (e.g., list of destination coordinates for the past 30 visits), and building spot information database (e.g., coordinates, category, congestion level, etc. for each spot) to a candidate generation AI module. The candidate generation AI, for example, uses a graph neural network or distance calculation algorithm to calculate Euclidean distance from the current location and relevance to past visited spots in high-dimensional space and generates a candidate list based on relevance scores. Examples of input to the AI include (1) current location vector [x=35.6895, y=139.6917, floor=3], (2) past visit history list (e.g., conference room 305, cafe A), and (3) spot information vector (e.g., coordinates and category for each spot). The AI output includes (1) candidate list with relevance scores (e.g., cafe A 50 m from current location=0.95), (2) estimated travel time (e.g., 2 minutes on foot), and (3) explanation text for each candidate (e.g., ‘Cafe A you visited before is nearby’). Examples of output include (1) ‘Display conference room 305 closest to the current location as a candidate,’ (2) ‘Prioritize cafe A visited in the past,’ and (3) ‘Display spots within a 2-minute walk at the top.’ The reception unit dynamically adjusts the order and explanation text of the candidate list on the user interface and highlights candidates that match the user's current location and movement history based on these AI outputs. Furthermore, if the user's current location changes, the AI model performs re-inference and immediately updates the candidate list. Unlike conventional static candidate presentation, the reception unit realizes optimal candidate presentation that responds to the user's movement situation by combining high-precision location information analysis and relevance scoring. Technical effects include improving the efficiency of destination selection, shortening travel time, and increasing user satisfaction. Application fields include building navigation reception terminals, guidance systems for commercial facilities, tourist information centers, and personalized service provision.

The reception unit can analyze the user's social media activity when inputting a destination and present relevant candidates. The reception unit, for example, analyzes the user's social media activity. For example, the reception unit presents relevant candidates based on places where the user has checked in on social media. In addition, the reception unit can present relevant candidates based on places visited by the user's friends. Furthermore, the reception unit can present relevant candidates based on places the user has shown interest in on social media. As a result, the reception unit can present relevant candidates to the user by analyzing social media activity. Some or all of the above-described processing in the reception unit may be performed using AI, or may be performed without using AI. For example, the reception unit may input the user's social media activity data to a generation AI, and the generation AI can present relevant candidates. Thus, the navigation system can present relevant candidates to the user by analyzing social media activity. Specifically, the reception unit acquires social media activity data from the user terminal or cloud service (e.g., check-in history list for the past year, post text, attached image information, friend list, like history, etc. as structured and unstructured data), performs preprocessing such as normalization, anonymization, natural language analysis, and image feature extraction, and inputs them to a social media analysis AI module. The social media analysis AI uses, for example, a multimodal architecture combining a large language model and an image recognition neural network to extract place names and facility names from post text, extract landmark features from images, and estimate visit tendencies from the friend network. Examples of input to the AI include (1) check-in history vector (e.g., spot ID=123, date and time=2024-06-01 12:00), (2) post text (e.g., ‘Lunch at cafe A’), and (3) friend visit history list (e.g., friend X checked in at store B). The AI output includes (1) relevant candidate spot list (e.g., cafe A, store B, tourist spot C), (2) relevance score for each candidate (e.g., cafe A=0.92), and (3) explanation text for each candidate (e.g., ‘Friend X visited recently,’ ‘Checked in before’). Examples of output include (1) ‘Display cafe A checked in before as a candidate,’ (2) ‘Prioritize store B visited by friend Y,’ and (3) ‘Display tourist spot C shown interest in posts at the top.’ The reception unit dynamically adjusts the order and explanation text of the candidate list on the user interface and highlights candidates that match the user's social media activity based on these AI outputs. Furthermore, if the user's activity history or friend network changes, the AI model performs re-inference and immediately updates the candidate list. Unlike conventional static candidate presentation or simple history reference, the reception unit realizes optimal candidate presentation that responds to the user's social context and interests by combining high-dimensional social graph analysis and multimodal data integration. Technical effects include improving the degree of personalization in destination selection, shortening input procedures, and greatly increasing user satisfaction. Application fields include building navigation reception terminals, guidance systems for commercial facilities, tourist information centers, personalized service provision, and crowd guidance at event venues.

The generation unit can estimate the user's emotion and adjust the route calculation method based on the estimated emotion. The generation unit, for example, estimates the user's emotion. For example, the generation unit estimates the user's emotion using methods such as facial expression recognition, voice analysis, and behavioral pattern analysis. In addition, the generation unit adjusts the route calculation method based on the estimated emotion. For example, if the user is relaxed, the generation unit prioritizes routes with good scenery. If the user is in a hurry, the generation unit can prioritize the shortest route. Furthermore, if the user is excited, the generation unit can prioritize routes with many activities. As a result, the generation unit can provide the optimal route to the user by adjusting the route calculation method according to the user's emotion. Emotion estimation is realized using, for example, an emotion engine or a generation AI with emotion estimation functions. The generation AI may be a text generation AI (e.g., LLM) or a multimodal generation AI, but is not limited to these examples. Some or all of the above-described processing in the generation unit may be performed using AI, or may be performed without using AI. For example, the generation unit may input the user's emotion data to a generation AI, and the generation AI can adjust the route calculation method. Thus, the navigation system can provide the optimal route to the user by adjusting the route calculation method according to the user's emotion. Specifically, the generation unit inputs emotion estimation data received from the reception unit or navigation unit (e.g., emotion label ‘relaxation,’ ‘hurry,’ ‘excitement,’ emotion intensity score 0.85, etc.), current location vector (e.g., x=35.6895, y=139.6917, floor=2), and destination attribute vector (e.g., building_id=123, floor=3, room=305) to a route generation AI module. The route generation AI uses, for example, a hybrid model that dynamically reflects the emotional state as a parameter in the route cost function or reward function in addition to graph neural networks and reinforcement learning algorithms. Examples of input to the AI include (1) emotion label (e.g., relaxation), (2) emotion intensity score (e.g., 0.7), (3) current location and destination vectors, and (4) building route graph structure data. The AI output includes (1) route node sequence optimized for the emotional state (e.g., route including scenic corridors, shortest route, route with many activities), (2) guidance text sequence for each route segment (e.g., ‘Take the elevator to the 3rd floor, there is a cafe on the right’), and (3) recommendation score for each route. Examples of output include (1) ‘Recommend scenic route due to relaxation,’ (2) ‘Present shortest route due to hurry,’ and (3) ‘Guide route with many activities due to excitement.’ The generation unit sends optimized route information to the user interface or navigation unit based on these AI outputs and realizes route guidance that responds to the user's emotional state. Furthermore, if the user's emotional state changes, the AI model performs re-inference and immediately recalculates the route. Unlike conventional uniform route calculation or subjective judgment by humans, the generation unit incorporates emotion parameters into high-dimensional route optimization algorithms, greatly improving guidance accuracy and the degree of personalization in user experience. Technical effects include flexible route guidance that responds to the user's psychological state and usage scene, improved travel satisfaction, and reduced misguidance. Application fields include building navigation, guidance for commercial facilities, tourist guides, patient guidance in medical institutions, and barrier-free support.

The generation unit can adjust the level of detail of the route based on the importance of the destination when generating the route. The generation unit, for example, adjusts the level of detail of the route based on the importance of the destination when generating the route. For example, if the destination is an important meeting, the generation unit provides detailed route guidance. If the destination is a tourist spot, the generation unit can provide a route that includes major tourist spots. Furthermore, if the destination is for shopping, the generation unit can provide a route that includes major stores. As a result, the generation unit can provide optimal route guidance to the user by adjusting the level of detail of the route according to the importance of the destination. Some or all of the above-described processing in the generation unit may be performed using AI, or may be performed without using AI. For example, the generation unit may input destination importance data to a generation AI, and the generation AI can adjust the level of detail of the route. Thus, the navigation system can provide optimal route guidance to the user by adjusting the level of detail of the route according to the importance of the destination. Specifically, the generation unit inputs the destination importance score (e.g., importance=0.95, category label such as meeting, sightseeing, shopping, etc.) acquired from the reception unit or user profile management unit, and the destination attribute vector (e.g., building_id=123, floor=3, room=305) to a route generation AI module. The route generation AI module, for example, uses a graph neural network or reinforcement learning algorithm and dynamically reflects the importance score as a parameter in the route cost function or detail level control parameter. Examples of input to the AI include (1) destination importance score (e.g., 0.95), (2) destination category label (e.g., meeting, sightseeing), (3) current location and destination vectors, and (4) building route graph structure data. The AI output includes (1) route node sequence with detail level control (e.g., only major nodes, all nodes in detail, via tourist spots, etc.), (2) guidance text sequence for each route segment (e.g., ‘Take the elevator to the 3rd floor, go straight to conference room 305’), and (3) detail level score for each route. Examples of output include (1) ‘Provide detailed guidance for all route segments for important meetings,’ ‘Guide route via major spots for sightseeing,’ and ‘Guide route via major stores for shopping.’ The generation unit sends optimized route information to the user interface or navigation unit based on these AI outputs and realizes route guidance with a level of detail according to the importance of the destination. Furthermore, if the importance of the destination changes or a new destination is added, the AI model performs re-inference and immediately readjusts the route detail level. Unlike conventional uniform route guidance or subjective detail level adjustment by humans, the generation unit incorporates importance parameters into high-dimensional route optimization algorithms, greatly improving guidance accuracy and the degree of personalization in user experience. Technical effects include flexible route guidance that responds to the user's purpose and usage scene, reduced misguidance and information shortage for important destinations, and optimal response to diverse needs such as sightseeing and shopping. Application fields include building navigation, guidance for commercial facilities, tourist guides, patient guidance in medical institutions, barrier-free support, and route guidance at event venues.

The generation unit can apply different route calculation algorithms according to the category of the destination when generating the route. The generation unit, for example, applies different route calculation algorithms according to the category of the destination when generating the route. For example, if the destination is for business, the generation unit applies a route calculation algorithm that enables arrival in the shortest time. If the destination is for sightseeing, the generation unit can apply a route calculation algorithm that prioritizes scenic routes. Furthermore, if the destination is for shopping, the generation unit can apply a route calculation algorithm that passes through major stores. As a result, the generation unit can provide the optimal route to the user by applying route calculation algorithms according to the category of the destination. Some or all of the above-described processing in the generation unit may be performed using AI, or may be performed without using AI. For example, the generation unit may input destination category data to a generation AI, and the generation AI can apply different route calculation algorithms. Thus, the navigation system can provide the optimal route to the user by applying route calculation algorithms according to the category of the destination. Specifically, the generation unit inputs the destination category label (e.g., business, sightseeing, shopping, etc.) acquired from the reception unit or user profile management unit, and the destination attribute vector (e.g., building_id=123, floor=3, room=305) to a route generation AI module. The route generation AI module, for example, internally implements multiple route search algorithms (e.g., Dijkstra's algorithm, A* search, graph search with landscape evaluation, store-optimized route algorithm, etc.) and automatically selects and applies the optimal algorithm according to the destination category. Examples of input to the AI include (1) destination category label (e.g., business, sightseeing), (2) current location and destination vectors, (3) building route graph structure data, and (4) auxiliary information such as landscape evaluation data and store list. The AI output includes (1) route node sequence optimized for the category (e.g., shortest time route, scenic route, route via major stores), (2) guidance text sequence for each route segment, and (3) recommendation score for each route. Examples of output include (1) ‘Guide shortest time route for business destination,’ ‘Guide scenic route for sightseeing destination,’ and ‘Guide route via major stores for shopping destination.’ The generation unit sends optimized route information to the user interface or navigation unit based on these AI outputs and realizes route guidance according to the destination category. Furthermore, if the destination category changes or multiple categories are mixed, the AI model combines multiple algorithms for optimization. Unlike conventional uniform route calculation or subjective algorithm selection by humans, the generation unit incorporates category parameters into high-dimensional route optimization algorithms, greatly improving guidance accuracy and the degree of personalization in user experience. Technical effects include flexible route guidance that responds to usage scenes and purposes, reduced misguidance and unsatisfactory route selection, and optimal response to multiple destination categories. Application fields include building navigation, guidance for commercial facilities, tourist guides, patient guidance in medical institutions, and route guidance at event venues.

The generation unit can estimate the user's emotion and adjust the length of the route based on the estimated emotion when generating the route. The generation unit, for example, estimates the user's emotion. For example, the generation unit estimates the user's emotion using methods such as facial expression recognition, voice analysis, and behavioral pattern analysis. In addition, the generation unit adjusts the length of the route based on the estimated emotion. For example, if the user is tired, the generation unit provides the shortest route. If the user is relaxed, the generation unit can provide a slightly longer route. Furthermore, if the user is excited, the generation unit can provide a route with many activities. As a result, the generation unit can provide the optimal route to the user by adjusting the length of the route according to the user's emotion. Emotion estimation is realized using, for example, an emotion engine or a generation AI with emotion estimation functions. The generation AI may be a text generation AI (e.g., LLM) or a multimodal generation AI, but is not limited to these examples. Some or all of the above-described processing in the generation unit may be performed using AI, or may be performed without using AI. For example, the generation unit may input the user's emotion data to a generation AI, and the generation AI can adjust the length of the route. Thus, the navigation system can provide the optimal route to the user by adjusting the length of the route according to the user's emotion. Specifically, the generation unit inputs emotion estimation data acquired from the reception unit or navigation unit (e.g., emotion label ‘fatigue,’ ‘relaxation,’ ‘excitement,’ emotion intensity score 0.85, etc.), current location vector (e.g., x=35.6895, y=139.6917, floor=2), and destination attribute vector (e.g., building_id=123, floor=3, room=305) to a route generation AI module. The route generation AI, for example, dynamically reflects the emotional state as a parameter in the route cost function or reward function and automatically adjusts the route length control parameter (e.g., shortest distance priority, detour tolerance, activity density, etc.) in addition to graph neural networks and reinforcement learning algorithms. Examples of input to the AI include (1) emotion label (e.g., fatigue), (2) emotion intensity score (e.g., 0.9), (3) current location and destination vectors, and (4) building route graph structure data. The AI output includes (1) route node sequence optimized for the emotional state (e.g., shortest route, detour route, route with many activities), (2) guidance text sequence for each route segment, and (3) recommendation score for each route. Examples of output include (1) ‘Guide shortest route due to fatigue,’ ‘Guide detour route due to relaxation,’ and ‘Guide route with many activities due to excitement.’ The generation unit sends optimized route information to the user interface or navigation unit based on these AI outputs and realizes route guidance that responds to the user's emotional state. Furthermore, if the user's emotional state changes, the AI model performs re-inference and immediately readjusts the route length. Unlike conventional uniform route calculation or subjective route length adjustment by humans, the generation unit incorporates emotion parameters into high-dimensional route optimization algorithms, greatly improving guidance accuracy and the degree of personalization in user experience. Technical effects include flexible route guidance that responds to the user's psychological state and usage scene, improved travel satisfaction, and reduced misguidance. Application fields include building navigation, guidance for commercial facilities, tourist guides, patient guidance in medical institutions, and barrier-free support.

The generation unit can determine the priority of the route based on the submission timing of the destination when generating the route. The generation unit, for example, determines the priority of the route based on the submission timing of the destination when generating the route. For example, if the destination is urgent, the generation unit prioritizes the route that enables arrival in the shortest time. If there is a scheduled event, the generation unit can prioritize the route that matches the scheduled time. Furthermore, if the destination is far away, the generation unit can prioritize the route that includes rest points along the way. As a result, the generation unit can provide the optimal route to the user by determining the priority of the route based on the submission timing of the destination. Some or all of the above-described processing in the generation unit may be performed using AI, or may be performed without using AI. For example, the generation unit may input destination submission timing data to a generation AI, and the generation AI can determine the priority of the route. Thus, the navigation system can provide the optimal route to the user by determining the priority of the route based on the submission timing of the destination. Specifically, the generation unit inputs destination submission time data (e.g., submission time=2024-06-01 09:00, urgency label=high, scheduled start time=10: 00, etc.) acquired from the reception unit or scheduler management unit, and destination attribute vector (e.g., building_id=123, floor=3, room=305) to a route generation AI module. The route generation AI, for example, uses a time series optimization algorithm or reinforcement learning algorithm and dynamically reflects the submission timing and urgency as parameters in the route cost function or priority control parameter. Examples of input to the AI include (1) submission time data (e.g., 2024-06-01 09:00), (2) urgency label (e.g., high), (3) scheduled start time (e.g., 10:00), (4) current location and destination vectors, and (5) building route graph structure data. The AI output includes (1) route node sequence with priority (e.g., urgent destination priority, scheduled time arrival optimization, route via rest points), (2) guidance text sequence for each route segment, and (3) priority score for each route. Examples of output include (1) ‘Prioritize shortest time route for urgent destination,’ ‘Guide route matching scheduled time,’ and ‘Guide route including rest points for long-distance travel.’ The generation unit sends optimized route information to the user interface or navigation unit based on these AI outputs and realizes route priority according to the submission timing of the destination. Furthermore, if the submission timing or urgency changes, the AI model performs re-inference and immediately readjusts the priority. Unlike conventional uniform route priority or subjective priority adjustment by humans, the generation unit incorporates submission timing parameters into high-dimensional route optimization algorithms, greatly improving guidance accuracy and the degree of personalization in user experience. Technical effects include flexible route guidance that responds to emergencies and schedule management, reduced arrival delays and misguidance, and improved comfort during long-distance travel. Application fields include building navigation, guidance for commercial facilities, tourist guides, patient guidance in medical institutions, route guidance at event venues, and route control for logistics robots.

The generation unit can adjust the order of the route based on the relevance of the destination when generating the route. The generation unit, for example, adjusts the order of the route based on the relevance of the destination when generating the route. For example, the generation unit provides a route that visits important destinations first. In addition, the generation unit can provide a route that visits related destinations consecutively. Furthermore, the generation unit can provide a route that visits destinations in the optimal order based on the user's interests. As a result, the generation unit can provide the optimal route to the user by adjusting the order of the route based on the relevance of the destination. Some or all of the above-described processing in the generation unit may be performed using AI, or may be performed without using AI. For example, the generation unit may input destination relevance data to a generation AI, and the generation AI can adjust the order of the route. Thus, the navigation system can provide the optimal route to the user by adjusting the order of the route based on the relevance of the destination. Specifically, the generation unit inputs the relevance score matrix for multiple destinations (e.g., destination A-B=0.9, A-C=0.3, etc.), destination importance vector, and user interest vector (e.g., meeting=0.8, cafe=0.6, etc.) acquired from the reception unit or user profile management unit to a route generation AI module. The route generation AI, for example, uses a traveling salesman problem optimization algorithm or a graph neural network and dynamically reflects relevance scores and interest levels as parameters for route order determination. Examples of input to the AI include (1) destination relevance score matrix, (2) destination importance vector, (3) user interest vector, (4) current location vector, and (5) building route graph structure data. The AI output includes (1) route order list optimized for relevance (e.g., important destination→related destination→destination with high interest), (2) guidance text sequence for each route segment, and (3) recommendation score for each route. Examples of output include (1) ‘Guide important destination first,’ ‘Guide related destinations consecutively,’ and ‘Guide destinations in order of high interest.’ The generation unit sends optimized route order information to the user interface or navigation unit based on these AI outputs and realizes route order according to the relevance of the destination. Furthermore, if destinations are added or relevance scores change, the AI model performs re-inference and immediately readjusts the order. Unlike conventional uniform route order or subjective order determination by humans, the generation unit incorporates relevance parameters into high-dimensional route optimization algorithms, greatly improving guidance accuracy and the degree of personalization in user experience. Technical effects include improved efficiency when visiting multiple destinations, shortened travel time, and increased user satisfaction. Application fields include building navigation, guidance for commercial facilities, tourist guides, patient guidance in medical institutions, route guidance at event venues, and route control for logistics robots.

The navigation unit can estimate the user's emotion and adjust the display method of navigation based on the estimated emotion. The navigation unit, for example, estimates the user's emotion. For example, the navigation unit estimates the user's emotion using methods such as facial expression recognition, voice analysis, and behavioral pattern analysis. In addition, the navigation unit adjusts the display method of navigation based on the estimated emotion. For example, if the user is nervous, the navigation unit provides a simple and highly visible display method. If the user is relaxed, the navigation unit can provide a display method that includes detailed information. Furthermore, if the user is in a hurry, the navigation unit can provide a display method that emphasizes key points. As a result, the navigation unit can provide optimal navigation to the user by adjusting the display method of navigation according to the user's emotion. Emotion estimation is realized using, for example, an emotion engine or a generation AI with emotion estimation functions. The generation AI may be a text generation AI (e.g., LLM) or a multimodal generation AI, but is not limited to these examples. Some or all of the above-described processing in the navigation unit may be performed using AI, or may be performed without using AI. For example, the navigation unit may input the user's emotion data to a generation AI, and the generation AI can adjust the display method of navigation. Thus, the navigation system can provide optimal navigation to the user by adjusting the display method of navigation according to the user's emotion. Specifically, the navigation unit inputs face image tensors acquired from the user terminal's camera (e.g., 224×224 pixel RGB images), voice waveform data acquired from the microphone (e.g., 1 second of audio sampled at 16 kHz), and behavioral log vectors such as touch operations and movement speed (e.g., tap interval, input speed, walking speed, etc.) to an emotion estimation AI module. The emotion estimation AI extracts facial expression features from face images using a convolutional neural network, analyzes voice tone and speech rate using a recurrent neural network for voice recognition, and analyzes behavioral patterns using a time series model (e.g., LSTM). Examples of input to the AI include (1) face image tensor (e.g., facial expressions of nervousness, relaxation, hurry), (2) voice waveform (e.g., utterances such as ‘I'm in a hurry,’ ‘I want to be guided slowly’), and (3) touch operation log (e.g., continuous taps, long presses, etc.). The AI output includes (1) emotion label (e.g., nervousness, relaxation, hurry), (2) emotion intensity score (e.g., nervousness level 0.85), and (3) recommended display mode (e.g., simple UI, detailed UI, key point emphasis UI). Examples of output include (1) ‘Recommend simple display due to high nervousness,’ (2) ‘Expand detailed information due to relaxation,’ and (3) ‘Emphasize only key points due to hurry.’ The navigation unit immediately switches the layout, information amount, font size, color scheme, and display timing of the user interface based on these AI outputs. For example, in a nervous state, unnecessary information is omitted and only the main route and current location are displayed prominently; in a relaxed state, surrounding facility information and route details are additionally displayed; in a hurry state, only the next action is emphasized. Furthermore, if the user's emotional state changes, a threshold judgment module triggers AI re-estimation and dynamically reconfigures the UI. Unlike conventional uniform navigation display, the navigation unit integrates high-precision emotion estimation using multimodal data and real-time UI optimization to realize a guidance experience that responds to the user's psychological state and usage situation. Technical effects include reducing user stress and input errors, improving guidance comprehension and arrival rate, and flexibly responding to diverse user attributes and usage scenes. Application fields include building navigation terminals, guidance systems for public facilities, patient guidance in medical institutions, and interface optimization for visually and hearing impaired persons.

The navigation unit can select an optimal navigation method by referring to the user's past movement history during navigation. For example, the navigation unit refers to the user's past movement history during navigation. For instance, the navigation unit proposes an optimal navigation method based on routes previously used by the user. Additionally, the navigation unit can propose navigation methods that avoid congestion based on the user's past movement history. Furthermore, the navigation unit can analyze the user's past movement history and propose the most efficient navigation method. Thus, by referring to past movement history, the navigation unit can provide the user with the optimal navigation method. Some or all of the above-described processes in the navigation unit may be performed using AI, or may be performed without using AI. For example, the navigation unit may input the user's past movement history data into a generative AI, and the generative AI can select the optimal navigation method. As a result, the navigation system can provide the user with the optimal navigation method by referring to past movement history. Specifically, the navigation unit inputs a movement history database recorded for each user (e.g., a structured table of node sequences of movement routes over the past year, movement date and time, required time, congestion level, means of transportation, etc.) into an analysis AI module. The analysis AI extracts the user's movement tendencies, congestion avoidance patterns, and route selection preferences using, for example, time-series clustering algorithms or autoregressive neural networks. Examples of AI input include: (1) node sequences of movement routes for the past 30 times (e.g., entrance→elevator→3rd floor→meeting room 305); (2) scalar values of congestion level for each time (e.g., 0.2 to 0.9); (3) label sequences of means of transportation (e.g., walking, elevator, stairs); (4) movement date and time vectors (e.g., 2024-06-01 09:00). AI outputs include: (1) a list of frequently used route candidates (e.g., shortest route to meeting room 305, congestion avoidance route); (2) recommended navigation means (e.g., elevator in the morning on weekdays, stairs in the afternoon on holidays); (3) a list of routes with congestion avoidance scores. Output examples include: (1) “Display as candidate the route used 8 out of the last 10 times”; (2) “Recommend routes with low congestion”; (3) “Recommend elevator use in the morning.” Based on these AI outputs, the navigation unit automatically displays candidate routes and highlights recommended navigation means on the user interface. Furthermore, as new movement history is accumulated for the user, the AI model continuously improves personalization accuracy through online learning. Unlike conventional static route presentation or uniform navigation means presentation, the navigation unit analyzes each user's history patterns in a high-dimensional vector space and provides a real-time optimized guidance experience. Technical effects include shortening movement procedures, improving congestion avoidance rates, and increasing user satisfaction. Application fields include building navigation terminals, guidance systems for public facilities, patient guidance in medical institutions, and service optimization for repeat users.

The navigation unit can select an optimal navigation method by referring to the user's past movement history during navigation. For example, the navigation unit refers to the user's past movement history during navigation. For instance, the navigation unit proposes an optimal navigation method based on routes previously used by the user. Additionally, the navigation unit can propose navigation methods that avoid congestion based on the user's past movement history. Furthermore, the navigation unit can analyze the user's past movement history and propose the most efficient navigation method. Thus, by referring to past movement history, the navigation unit can provide the user with the optimal navigation method. Some or all of the above-described processes in the navigation unit may be performed using AI, or may be performed without using AI. For example, the navigation unit may input the user's past movement history data into a generative AI, and the generative AI can select the optimal navigation method. As a result, the navigation system can provide the user with the optimal navigation method by referring to past movement history. Specifically, the navigation unit inputs a movement history database recorded for each user (e.g., a structured table of node sequences of movement routes over the past year, movement date and time, required time, congestion level, means of transportation, etc.) into an analysis AI module. The analysis AI extracts the user's movement tendencies, congestion avoidance patterns, and route selection preferences using time-series clustering algorithms or autoregressive neural networks. Examples of AI input include: (1) node sequences of movement routes for the past 30 times (e.g., entrance→elevator→3rd floor→meeting room 305); (2) scalar values of congestion level for each time (e.g., 0.2 to 0.9); (3) label sequences of means of transportation (e.g., walking, elevator, stairs); (4) movement date and time vectors (e.g., 2024-06-01 09:00). AI outputs include: (1) a list of frequently used route candidates (e.g., shortest route to meeting room 305, congestion avoidance route); (2) recommended navigation means (e.g., elevator in the morning on weekdays, stairs in the afternoon on holidays); (3) a list of routes with congestion avoidance scores. Output examples include: (1) “Display as candidate the route used 8 out of the last 10 times”; (2) “Recommend routes with low congestion”; (3) “Recommend elevator use in the morning.” Based on these AI outputs, the navigation unit automatically displays candidate routes and highlights recommended navigation means on the user interface. Furthermore, as new movement history is accumulated for the user, the AI model continuously improves personalization accuracy through online learning. Unlike conventional static route presentation or uniform navigation means presentation, the navigation unit analyzes each user's history patterns in a high-dimensional vector space and provides a real-time optimized guidance experience. Technical effects include shortening movement procedures, improving congestion avoidance rates, and increasing user satisfaction. Application fields include building navigation terminals, guidance systems for public facilities, patient guidance in medical institutions, and service optimization for repeat users.

The navigation unit can customize the means of navigation based on the user's current situation during navigation. For example, the navigation unit customizes the means of navigation based on the user's current situation during navigation. For instance, if the user is moving on foot, the navigation unit provides navigation for walking. If the user is traveling by car, the navigation unit can provide navigation for driving. Furthermore, if the user is using public transportation, the navigation unit can provide navigation for public transportation. Thus, the navigation unit can provide the optimal means of navigation according to the user's current situation. Some or all of the above-described processes in the navigation unit may be performed using AI, or may be performed without using AI. For example, the navigation unit may input the user's current situation data into a generative AI, and the generative AI can customize the means of navigation. As a result, the navigation system can provide the optimal means of navigation according to the user's current situation. Specifically, the navigation unit analyzes movement means determination data obtained from the user terminal (e.g., acceleration and gyro sensor values, GPS speed vectors, transit IC card usage history, etc.) in a preprocessing module and inputs it into a movement means classification AI module. The movement means classification AI uses convolutional neural networks and time-series models (e.g., LSTM) to accurately determine means of movement such as walking, driving, or public transportation. Examples of AI input include: (1) time-series acceleration and gyro sensor values (e.g., walking patterns, vehicle vibration patterns); (2) GPS speed vectors (e.g., 0-1.5 m/s for walking, 10 m/s or more for driving); (3) transit IC card usage history (e.g., ticket gate passage records). AI outputs include: (1) movement means labels (e.g., walking, car, train); (2) recommended navigation modes (e.g., UI for walking, UI for driving, UI for public transportation); (3) movement means confidence scores. Output examples include: (1) “Display navigation for walking as the user is currently walking”; (2) “Guide car route as the user is driving”; (3) “Emphasize transfer guidance as the user is using public transportation.” Based on these AI outputs, the navigation unit instantly switches user interfaces and route calculation algorithms to provide guidance optimized for the means of movement. Furthermore, if the user's means of movement changes, the AI model performs re-inference and immediately readjusts the means of navigation. Unlike conventional uniform navigation means presentation, the navigation unit combines multidimensional sensor data and AI classification technology to realize an optimal guidance experience that responds instantly to the user's movement situation. Technical effects include reduction of guidance errors due to misrecognition of movement means, improvement of movement efficiency, and increased user satisfaction. Application fields include building navigation terminals, guidance systems for commercial facilities, tourist guides, patient guidance in medical institutions, and barrier-free support.

The navigation unit can estimate the user's emotion and determine the priority of navigation based on the estimated emotion. For example, the navigation unit estimates the user's emotion using methods such as facial recognition, voice analysis, and behavioral pattern analysis. The navigation unit then determines the priority of navigation based on the estimated emotion. For instance, if the user is nervous, the navigation unit prioritizes the display of important information. If the user is relaxed, the navigation unit can prioritize the display of detailed information. Furthermore, if the user is in a hurry, the navigation unit can prioritize the display of key information. Thus, by determining the priority of navigation according to the user's emotion, the navigation unit can provide the user with optimal information. Emotion estimation may be realized using an emotion engine or generative AI, such as a text generation AI (e.g., LLM) or multimodal generative AI, but is not limited to these examples. Some or all of the above-described processes in the navigation unit may be performed using AI, or may be performed without using AI. For example, the navigation unit may input the user's emotion data into a generative AI, and the generative AI can determine the priority of navigation. As a result, the navigation system can provide the user with optimal information by determining the priority of navigation according to the user's emotion. Specifically, the navigation unit inputs facial image tensors obtained from the user terminal's camera (e.g., 224×224 pixel RGB images), voice waveform data (e.g., 1 second of audio), and touch operation logs (e.g., input speed, tap intervals, etc.) into an emotion estimation AI module. The emotion estimation AI extracts facial features using convolutional neural networks, analyzes voice tone and speech rate using recurrent neural networks for voice recognition, and analyzes behavioral patterns using time-series models. Examples of AI input include: (1) facial image tensors (e.g., expressions of nervousness, relaxation, hurry); (2) voice waveforms (e.g., utterances such as “I'm in a hurry,” “Please guide me slowly”); (3) touch operation logs (e.g., consecutive taps, long presses). AI outputs include: (1) emotion labels (e.g., nervous, relaxed, hurried); (2) emotion intensity scores (e.g., nervousness level 0.85); (3) navigation information priority lists (e.g., important information ranked first, detailed information second, key information third). Output examples include: (1) “Display important information at the top due to high nervousness”; (2) “Prioritize detailed information due to relaxed state”; (3) “Emphasize only key points due to hurried state.” Based on these AI outputs, the navigation unit dynamically adjusts the order and emphasis of information on the user interface to present information tailored to the user's emotional state. Furthermore, if the emotional state changes, the AI model performs re-inference and instantly updates the information priority. Unlike conventional uniform information presentation, the navigation unit combines multimodal emotion estimation and information priority optimization to realize a guidance experience that responds instantly to the user's psychological state. Technical effects include improved guidance comprehension, reduced misguidance, and increased user satisfaction. Application fields include building navigation terminals, guidance systems for public facilities, patient guidance in medical institutions, and optimization of barrier-free interfaces.

The navigation unit can select an optimal navigation method by considering the user's geographic location information during navigation. For example, the navigation unit considers the user's geographic location information during navigation. For instance, the navigation unit prioritizes navigation to places close to the user's current location. The navigation unit can also navigate to related spots near places the user has visited in the past. Furthermore, the navigation unit can provide the optimal navigation method by considering the travel time from the user's current location. Thus, by considering the user's geographic location information, the navigation unit can provide the optimal navigation method. Some or all of the above-described processes in the navigation unit may be performed using AI, or may be performed without using AI. For example, the navigation unit may input the user's geographic location information data into a generative AI, and the generative AI can select the optimal navigation method. As a result, the navigation system can provide the optimal navigation method by considering the user's geographic location information. Specifically, the navigation unit inputs the current location vector obtained from the user terminal (e.g., x=35.6895, y=139.6917, floor=3), past visit history vectors (e.g., list of destination coordinates for the past 30 visits), and building spot information database (e.g., coordinates, categories, congestion level of each spot) into a candidate generation AI module. The candidate generation AI uses graph neural networks and distance calculation algorithms to calculate Euclidean distances from the current location and relevance to past visited spots in a high-dimensional space, generating a navigation candidate list based on relevance scores. Examples of AI input include: (1) current location vector [x=35.6895, y=139.6917, floor=3]; (2) past visit history list (e.g., meeting room 305, cafe A); (3) spot information vectors (e.g., coordinates and categories of each spot). AI outputs include: (1) candidate list with relevance scores (e.g., cafe A 50 m from current location=0.95); (2) estimated travel time (e.g., 2 minutes on foot); (3) explanation text for each candidate (e.g., “Cafe A, which you visited before, is nearby”). Output examples include: (1) “Display meeting room 305, which is closest to the current location, as a candidate”; (2) “Prioritize cafe A, which was visited in the past”; (3) “Display spots within a 2-minute walk at the top.” Based on these AI outputs, the navigation unit dynamically adjusts the order and explanation text of the candidate list on the user interface, emphasizing navigation tailored to the user's current location and movement history. Furthermore, if the user's current location changes, the AI model performs re-inference and instantly updates the candidate list. Unlike conventional static candidate presentation, the navigation unit combines high-precision location information analysis and relevance scoring to realize optimal navigation presentation that responds instantly to the user's movement situation. Technical effects include improved efficiency in destination selection, reduced travel time, and increased user satisfaction. Application fields include building navigation terminals, guidance systems for commercial facilities, tourist information centers, and personalized service provision.

The navigation unit can analyze the user's social media activity during navigation and propose means of navigation. For example, the navigation unit analyzes the user's social media activity during navigation. For instance, the navigation unit proposes related means of navigation based on places where the user has checked in on social media. The navigation unit can also propose related means of navigation based on places visited by the user's friends. Furthermore, the navigation unit can propose related means of navigation based on places where the user has shown interest on social media. Thus, by analyzing social media activity, the navigation unit can provide the user with relevant means of navigation. Some or all of the above-described processes in the navigation unit may be performed using AI, or may be performed without using AI. For example, the navigation unit may input the user's social media activity data into a generative AI, and the generative AI can propose means of navigation. As a result, the navigation system can provide the user with relevant means of navigation by analyzing social media activity. Specifically, the navigation unit obtains social media activity data from the user terminal or cloud services (e.g., check-in history list for the past year, post text, attached image information, friend list, like history, etc., including both structured and unstructured data), normalizes, anonymizes, performs natural language analysis, and extracts image features in a preprocessing module, and inputs the data into a social media analysis AI module. The social media analysis AI uses a multimodal architecture combining large language models and image recognition neural networks to extract place names and facility names from post text, landmark features from images, and visit tendencies from friend networks. Examples of AI input include: (1) check-in history vectors (e.g., spot ID=123, date and time=2024-06-01 12:00); (2) post text (e.g., “Lunch at cafe A”); (3) friend visit history list (e.g., friend X checked in at store B). AI outputs include: (1) list of related candidate spots (e.g., cafe A, store B, tourist spot C); (2) relevance score for each candidate (e.g., cafe A=0.92); (3) explanation text for each candidate (e.g., “Friend X visited recently,” “Checked in before”). Output examples include: (1) “Display cafe A, which was checked in before, as a candidate”; (2) “Prioritize store B, which friend Y visited”; (3) “Display tourist spot C, which was shown interest in posts, at the top.” Based on these AI outputs, the navigation unit dynamically adjusts the order and explanation text of the candidate list on the user interface, emphasizing means of navigation tailored to the user's social media activity. Furthermore, if the user's activity history or friend network changes, the AI model performs re-inference and instantly updates the candidate list. Unlike conventional static candidate presentation or simple history reference, the navigation unit combines high-dimensional social graph analysis and multimodal data integration to realize optimal means of navigation presentation that responds instantly to the user's social context and interests. Technical effects include improved personalization of destination selection, shortened guidance procedures, and greatly increased user satisfaction. Application fields include building navigation terminals, guidance systems for commercial facilities, tourist information centers, personalized service provision, and crowd guidance at event venues.

The provision unit can estimate the user's emotion and adjust the content of notifications based on the estimated emotion. For example, the provision unit estimates the user's emotion using methods such as facial recognition, voice analysis, and behavioral pattern analysis. The provision unit then adjusts the content of notifications based on the estimated emotion. For instance, if the user is nervous, the provision unit sends notifications in a calm tone. If the user is relaxed, the provision unit can send notifications in a cheerful tone. Furthermore, if the user is in a hurry, the provision unit can send quick and concise notifications. Thus, by adjusting the content of notifications according to the user's emotion, the provision unit can provide the user with optimal notifications. Emotion estimation may be realized using an emotion engine or generative AI, such as a text generation AI (e.g., LLM) or multimodal generative AI, but is not limited to these examples. Some or all of the above-described processes in the provision unit may be performed using AI, or may be performed without using AI. For example, the provision unit may input the user's emotion data into a generative AI, and the generative AI can adjust the content of notifications. As a result, the navigation system can provide the user with optimal notifications by adjusting the content of notifications according to the user's emotion. Specifically, the provision unit inputs facial image tensors obtained from the user terminal's camera (e.g., 224×224 pixel RGB images), voice waveform data obtained from the microphone (e.g., 1 second of audio sampled at 16 kHz), and behavioral log vectors such as touch operations and movement speed (e.g., tap intervals, input speed, walking speed, etc.) into an emotion estimation AI module. The emotion estimation AI extracts facial features from images using convolutional neural networks, analyzes voice tone and speech rate using recurrent neural networks for voice recognition, and analyzes behavioral patterns using time-series models (e.g., LSTM). Examples of AI input include: (1) facial image tensors (e.g., expressions of nervousness, relaxation, hurry); (2) voice waveforms (e.g., utterances such as “I'm in a hurry,” “Please notify me slowly”); (3) touch operation logs (e.g., consecutive taps, long presses). AI outputs include: (1) emotion labels (e.g., nervous, relaxed, hurried); (2) emotion intensity scores (e.g., nervousness level 0.85); (3) recommended notification modes (e.g., calm tone, cheerful tone, concise notification). Output examples include: (1) “Send notification in a calm tone due to high nervousness,” “Send notification in a cheerful tone due to relaxed state,” “Send concise notification due to hurried state.” Based on these AI outputs, the provision unit dynamically generates notification text, voice synthesis scripts, and display layouts in a notification generation module, and sends optimal notifications to the user terminal. For example, in a nervous state, the notification text is made simple, and in the case of voice notification, synthesized with a lower tone; in a relaxed state, emojis and cheerful expressions are added; in a hurried state, only key points are notified in short sentences. Furthermore, if the user's emotional state changes, the AI model performs re-inference and instantly readjusts the notification content. Unlike conventional uniform notification content or subjective notification text creation by humans, the provision unit combines multimodal emotion estimation and notification content generation AI to realize personalized notifications that respond instantly to the user's psychological state and usage situation. Technical effects include improved notification comprehension and response rates, reduced misunderstanding and stress, and increased user satisfaction. Application fields include building navigation terminals, guidance systems for public facilities, patient guidance in medical institutions, optimization of barrier-free interfaces, and emergency evacuation notifications.

The provision unit can select the optimal notification method by referring to the user's past notification history during notification. For example, the provision unit refers to the user's past notification history during notification. For instance, the provision unit preferentially selects notification methods (push notification, email, etc.) that the user has preferred to receive in the past. The provision unit can also select the optimal notification method for specific time periods based on the user's past notification history. Furthermore, the provision unit can analyze the user's past notification history and select the most effective notification method. Thus, by referring to past notification history, the provision unit can provide the user with the optimal notification method. Some or all of the above-described processes in the provision unit may be performed using AI, or may be performed without using AI. For example, the provision unit may input the user's past notification history data into a generative AI, and the generative AI can select the optimal notification method. As a result, the navigation system can provide the user with the optimal notification method by referring to past notification history. Specifically, the provision unit inputs a notification history database recorded for each user in chronological order (e.g., structured table of notification types over the past year, receipt date and time, read/unread flags, response time, notification method type, etc.) into an analysis AI module. The analysis AI extracts the user's notification receipt tendencies, notification method preferences by time period, and notification methods with high response rates using, for example, time-series clustering algorithms or autoregressive neural networks. Examples of AI input include: (1) notification type sequence for the past 30 times (e.g., push notification, email, voice notification); (2) receipt date and time vectors for each time (e.g., 2024-06-01 09:00); (3) read/unread flag sequence; (4) response time scalar values (e.g., 5 seconds, 30 seconds). AI outputs include: (1) recommended notification method list (e.g., push notification in the morning on weekdays, email in the afternoon on holidays); (2) optimal notification method by time period (e.g., suppress voice notification at night); (3) notification method with predicted response rate scores. Output examples include: (1) “Prioritize push notifications that were read 8 out of the last 10 times”; (2) “Recommend email notifications in the morning”; (3) “Recommend vibration notifications at night.” Based on these AI outputs, the provision unit automatically selects the optimal notification method according to the user terminal and usage situation, and instantly sends notifications via the notification transmission module. Furthermore, as new notification history is accumulated for the user, the AI model continuously improves personalization accuracy through online learning. Unlike conventional static notification method selection or uniform notification method presentation, the provision unit analyzes each user's history patterns in a high-dimensional vector space and provides a real-time optimized notification experience. Technical effects include improved notification delivery and response rates, reduced unnecessary notifications, and increased user satisfaction. Application fields include building navigation terminals, guidance systems for public facilities, patient guidance in medical institutions, service optimization for repeat users, and optimization of notification methods in emergencies.

The provision unit can adjust the content of notifications based on the user's current situation during notification. For example, the provision unit adjusts the content of notifications based on the user's current situation during notification. For instance, if the user is in a meeting, the provision unit selects a quiet notification method. If the user is on the move, the provision unit can provide concise notification content. Furthermore, if the user is relaxed, the provision unit can provide detailed notification content. Thus, by adjusting the content of notifications according to the user's current situation, the provision unit can provide the user with optimal notifications. Some or all of the above-described processes in the provision unit may be performed using AI, or may be performed without using AI. For example, the provision unit may input the user's current situation data into a generative AI, and the generative AI can adjust the content of notifications. As a result, the navigation system can provide the user with optimal notifications by adjusting the content of notifications according to the user's current situation. Specifically, the provision unit analyzes current situation data obtained from the user terminal (e.g., calendar schedule information, acceleration and gyro sensor values, GPS speed vectors, terminal silent mode settings, application usage status, etc.) in a preprocessing module and inputs it into a situation determination AI module. The situation determination AI uses convolutional neural networks and time-series models (e.g., LSTM) to accurately determine user states such as in a meeting, on the move, or relaxed. Examples of AI input include: (1) calendar schedule (e.g., meeting 10:00-11: 00); (2) time-series acceleration and gyro sensor values (e.g., stationary, walking, running); (3) terminal mode settings (e.g., silent, vibration); (4) application usage status (e.g., video conference app running). AI outputs include: (1) user state labels (e.g., in a meeting, on the move, relaxed); (2) recommended notification content modes (e.g., silent notification, concise notification, detailed notification); (3) notification content generation parameters. Output examples include: (1) “Recommend vibration notification due to being in a meeting,” “Generate concise notification text due to being on the move,” “Generate detailed notification content due to being relaxed.” Based on these AI outputs, the provision unit dynamically generates notification text, voice synthesis scripts, and display layouts in a notification generation module, and sends optimal notifications to the user terminal. Furthermore, if the user's situation changes, the AI model performs re-inference and instantly readjusts the notification content and method. Unlike conventional uniform notification content or subjective notification text creation by humans, the provision unit combines multidimensional situation data and AI determination technology to realize personalized notifications that respond instantly to the user's usage situation. Technical effects include improved notification acceptance and comprehension, reduced erroneous notifications and stress, and increased user satisfaction. Application fields include building navigation terminals, guidance systems for public facilities, patient guidance in medical institutions, optimization of barrier-free interfaces, and situation-adaptive notifications in emergencies.

The provision unit can estimate the user's emotion and determine the priority of notifications based on the estimated emotion. For example, the provision unit estimates the user's emotion using methods such as facial recognition, voice analysis, and behavioral pattern analysis. The provision unit then determines the priority of notifications based on the estimated emotion. For instance, if the user is nervous, the provision unit prioritizes the display of important notifications. If the user is relaxed, the provision unit can prioritize the display of detailed notifications. Furthermore, if the user is in a hurry, the provision unit can prioritize the display of key notifications. Thus, by determining the priority of notifications according to the user's emotion, the provision unit can provide the user with optimal notifications. Emotion estimation may be realized using an emotion engine or generative AI, such as a text generation AI (e.g., LLM) or multimodal generative AI, but is not limited to these examples. Some or all of the above-described processes in the provision unit may be performed using AI, or may be performed without using AI. For example, the provision unit may input the user's emotion data into a generative AI, and the generative AI can determine the priority of notifications. As a result, the navigation system can provide the user with optimal notifications by determining the priority of notifications according to the user's emotion. Specifically, the provision unit inputs facial image tensors obtained from the user terminal's camera (e.g., 224×224 pixel RGB images), voice waveform data (e.g., 1 second of audio), and touch operation logs (e.g., input speed, tap intervals, etc.) into an emotion estimation AI module. The emotion estimation AI extracts facial features using convolutional neural networks, analyzes voice tone and speech rate using recurrent neural networks for voice recognition, and analyzes behavioral patterns using time-series models. Examples of AI input include: (1) facial image tensors (e.g., expressions of nervousness, relaxation, hurry); (2) voice waveforms (e.g., utterances such as “I'm in a hurry,” “Please notify me slowly”); (3) touch operation logs (e.g., consecutive taps, long presses). AI outputs include: (1) emotion labels (e.g., nervous, relaxed, hurried); (2) emotion intensity scores (e.g., nervousness level 0.85); (3) notification information priority lists (e.g., important notifications ranked first, detailed notifications second, key notifications third). Output examples include: (1) “Display important notifications at the top due to high nervousness”; (2) “Prioritize detailed notifications due to relaxed state”; (3) “Emphasize only key points due to hurried state.” Based on these AI outputs, the provision unit dynamically adjusts the order and emphasis of notifications in the notification list to present notifications tailored to the user's emotional state. Furthermore, if the emotional state changes, the AI model performs re-inference and instantly updates the notification priority. Unlike conventional uniform notification presentation, the provision unit combines multimodal emotion estimation and notification priority optimization to realize a guidance experience that responds instantly to the user's psychological state. Technical effects include improved notification comprehension, reduced erroneous notifications, and increased user satisfaction. Application fields include building navigation terminals, guidance systems for public facilities, patient guidance in medical institutions, and optimization of barrier-free interfaces.

The provision unit can select the optimal notification method by considering the user's device information during notification. For example, the provision unit considers the user's device information during notification. For instance, if the user is using a smartphone, the provision unit preferentially selects push notifications. If the user is using a tablet, the provision unit can preferentially select email notifications. Furthermore, if the user is using a smartwatch, the provision unit can preferentially select vibration notifications. Thus, by considering the user's device information, the provision unit can provide the optimal notification method. Some or all of the above-described processes in the provision unit may be performed using AI, or may be performed without using AI. For example, the provision unit may input the user's device information data into a generative AI, and the generative AI can select the optimal notification method. As a result, the navigation system can provide the optimal notification method by considering the user's device information. Specifically, the provision unit inputs device information data obtained from the user terminal (e.g., device type label, OS version, screen size, notification settings, connection status, etc.) into a device determination AI module. The device determination AI uses classification algorithms and large language models to accurately determine device types such as smartphone, tablet, or smartwatch, and infers the optimal notification method for each device. Examples of AI input include: (1) device type label (e.g., smartphone, tablet, smartwatch); (2) notification settings (e.g., push notification ON, vibration ON); (3) screen size (e.g., 5.5 inches, 10 inches); (4) OS version (e.g., Android 13, iOS 17). AI outputs include: (1) recommended notification method (e.g., push notification for smartphone, email notification for tablet, vibration notification for smartwatch); (2) notification content optimization parameters (e.g., short text, long text, vibration pattern); (3) notification destination device list. Output examples include: (1) “Send push notification as smartphone is in use,” “Send email notification as tablet is in use,” “Send vibration notification as smartwatch is in use.” Based on these AI outputs, the provision unit automatically selects the optimal notification method according to the device type and instantly sends notifications to the user terminal via the notification transmission module. Furthermore, if the user is using multiple devices, the AI model optimizes the notification destination according to usage status and priority. Unlike conventional uniform notification method selection or notification transmission ignoring device type, the provision unit combines device information analysis and AI optimization technology to realize a notification experience that responds instantly to the user's device usage. Technical effects include improved notification delivery rate and immediacy, reduced erroneous notifications and missed notifications, and increased user satisfaction. Application fields include building navigation terminals, guidance systems for public facilities, patient guidance in medical institutions, and notification optimization in multi-device environments.

The system according to the embodiment is not limited to the examples described above, and various modifications are possible, for example, as follows. Specifically, the system can flexibly accommodate diverse hardware configurations and software architectures through modular design of each component such as the reception unit, generation unit, navigation unit, and provision unit. The system can realize not only a centralized configuration in which all functions are processed on a single server, but also a distributed configuration in which the reception unit is placed on edge terminals (e.g., building reception terminals or smartphones) and the generation unit and navigation unit are executed on cloud-based GPU parallel computing clusters. The system also allows for various choices regarding the type and training method of AI models. For example, emotion estimation AI may be selected from convolutional neural networks, recurrent neural networks, Transformer-based large language models, or multimodal integration models according to application and accuracy requirements. For route generation AI, combinations of graph neural networks, reinforcement learning algorithms, and traveling salesman problem optimization algorithms may be used. Furthermore, for management of user profiles and history data, local storage, cloud databases, or distributed ledger technologies may be adopted, allowing flexible design changes according to security requirements and privacy protection policies. For AI training data, various data sources such as custom datasets for each building, publicly available datasets, and data augmentation by synthetic data generation can be utilized. Additionally, for user interfaces, various input/output methods such as touch panels, voice recognition, gesture recognition, and AR glasses integration can be combined. As a technical effect, the system realizes the optimal system configuration according to the installation environment and user attributes through modularization, decentralization, and support for diverse AI architectures, greatly improving scalability, maintainability, and degree of personalization. Application fields include building navigation, commercial facility guidance, tourist guides, patient guidance in medical institutions, barrier-free support, event venue route guidance, logistics robot route control, and smart city integrated guidance systems, enabling deployment in an extremely wide range of fields.

The navigation system may further comprise a voice guidance unit. The voice guidance unit can provide real-time voice guidance as the user heads toward the destination. For example, the voice guidance unit can guide the user when boarding an elevator by saying, “Please take the elevator to the third floor.” The voice guidance unit can also guide the user when using stairs by saying, “Go up the stairs and turn right.” Furthermore, when the user approaches the destination, the voice guidance unit can say, “The destination is ahead on your right.” Thus, the user can reach the destination smoothly by utilizing not only visual information but also auditory information. Specifically, the navigation system comprises a voice synthesis AI module and a voice output control module as the voice guidance unit. The voice synthesis AI module receives guidance text sequences (e.g., “Take the elevator to the third floor,” “Go up the stairs and turn right,” etc.) from the route generation AI or navigation unit as input and generates natural speech waveform data (e.g., 16 kHz sampling, 1-5 second audio clips). Voice synthesis AI may include WaveNet-type neural vocoders, Transformer-based speech generation models, or emotion parameter-controlled speech synthesis models. Examples of AI input include: (1) guidance text (e.g., “The destination is ahead on your right”); (2) emotion tone parameters (e.g., calm tone, cheerful tone); (3) user attributes (e.g., slow speech for elderly users). AI outputs include: (1) speech waveform data (e.g., wav files); (2) speech speed, volume, and tone control parameters; (3) voice guidance history logs. Output examples include: (1) an audio clip saying “Please take the elevator to the third floor”; (2) clear speech saying “Go up the stairs and turn right”; (3) guidance audio saying “The destination is ahead on your right.” The voice output control module controls the timing and volume of guidance in real time for user terminal speakers, Bluetooth earphones, hearing aid devices, etc. Furthermore, the frequency and content of voice guidance can be dynamically optimized according to the user's movement speed, emotional state, and ambient noise level. For example, the volume is automatically adjusted in noisy environments, and guidance is provided in a calm tone for nervous users. Unlike conventional static voice guidance or simple text-to-speech, the voice guidance unit combines dynamic voice generation by AI and user state-adaptive control to improve guidance comprehension and arrival rates, and enhance accessibility for visually impaired and elderly users. Application fields include building navigation terminals, guidance systems for public facilities, patient guidance in medical institutions, barrier-free support, tourist guides, and event venue route guidance.

The navigation unit can measure the user's movement speed in real time and adjust the route according to the movement speed. For example, if the user is in a hurry, the navigation unit can prioritize guidance for the shortest route. If the user is moving slowly, the navigation unit can propose routes that include scenic paths or rest spots. Furthermore, if the user is moving at a constant speed, the navigation unit can dynamically change the route to avoid congestion. Thus, the user can reach the destination via the optimal route according to their movement speed. Specifically, the navigation unit obtains movement speed data (e.g., 0.5 m/s, 1.2 m/s, 3.0 m/s, etc.) in real time from the user terminal's acceleration sensor, gyro sensor, and GPS speed vector, processes it in a preprocessing module for noise removal, smoothing, and anomaly detection, and inputs it into a speed determination AI module. The speed determination AI uses time-series models (e.g., LSTM) and clustering algorithms to accurately determine the user's movement speed state (e.g., hurried, normal, slow). Examples of AI input include: (1) time-series acceleration and gyro sensor values (e.g., walking, running patterns); (2) GPS speed vector (e.g., 1.2 m/s); (3) movement means label (e.g., walking, car). AI outputs include: (1) speed state label (e.g., hurried, normal, slow); (2) recommended route type (e.g., shortest distance, scenic route, route via rest spots); (3) speed change detection flag. Output examples include: (1) “Guide the shortest route due to hurried state”; (2) “Guide scenic route due to slow movement”; (3) “Guide congestion avoidance route due to constant speed movement.” Based on these AI outputs, the navigation unit dynamically reflects speed state parameters in the route generation AI, automatically adjusting route cost functions and reward functions. Furthermore, if the user's speed changes, the AI model performs re-inference and instantly recalculates the route. Unlike conventional uniform route guidance or subjective speed judgment by humans, the navigation unit combines multidimensional sensor data and AI determination technology to realize an optimal guidance experience that responds instantly to the user's movement situation. Technical effects include improved movement efficiency, reduced misguidance, and increased user satisfaction. Application fields include building navigation terminals, guidance systems for commercial facilities, tourist guides, patient guidance in medical institutions, and barrier-free support.

The navigation unit can obtain environmental information such as temperature and humidity inside the building and propose comfortable routes. For example, if the temperature inside the building is high, the navigation unit can prioritize guidance for cooler routes. If the humidity is high, the navigation unit can propose routes through dry areas. Furthermore, if the air quality inside the building is poor, the navigation unit can propose routes through areas with good air quality. Thus, the user can reach the destination in a comfortable environment. Specifically, the navigation unit collects real-time environmental data (e.g., temperature 25° C., humidity 60%, CO2=800 ppm, etc.) from IoT environmental sensor groups installed inside the building (e.g., temperature sensors, humidity sensors, CO2 sensors, PM2.5 sensors, etc.) and stores it in an environmental information database. The navigation unit inputs the user's current location vector and destination vector, as well as the environmental information database, into a route generation AI module. The route generation AI uses graph neural networks and environmental comfort evaluation algorithms to calculate comfort scores for each route segment (e.g., temperature comfort 0.9, humidity comfort 0.8, air quality comfort 0.95, etc.) and automatically selects the route with the highest overall comfort. Examples of AI input include: (1) temperature, humidity, and air quality vectors (e.g., environmental values for each segment); (2) current location and destination vectors; (3) building route graph structure data. AI outputs include: (1) comfort-optimized route node sequence (e.g., route via cool segments, route via dry areas, route via areas with good air quality); (2) comfort scores for each route segment; (3) guidance text sequence. Output examples include: (1) “Guide cool route due to high temperature”; (2) “Route via dry area due to high humidity”; (3) “Prioritize route via areas with good air quality.” Based on these AI outputs, the navigation unit emphasizes comfort information in the user interface and voice guidance unit, supporting route selection according to the user's physical condition and preferences. Furthermore, if environmental information changes, the AI model performs re-inference and instantly recalculates the route. Unlike conventional uniform route guidance or subjective environmental judgment by humans, the navigation unit combines IoT sensor data and AI comfort optimization technology to realize a guidance experience that responds instantly to the user's health and comfort. Technical effects include reduced risk of heatstroke and discomfort, provision of a comfortable movement experience, and increased user satisfaction. Application fields include building navigation terminals, patient guidance in medical institutions, barrier-free support, and comfortable route guidance in commercial facilities.

The navigation unit can adjust the route by considering the lighting conditions inside the building. For example, the navigation unit can propose routes that avoid dark areas and pass through well-lit areas. The navigation unit can also prioritize guidance for routes with sufficient lighting during nighttime or periods with little lighting. Furthermore, if the user feels visually uneasy, the navigation unit can propose routes through well-lit areas. Thus, the user can reach the destination with peace of mind. Specifically, the navigation unit obtains real-time lighting condition data (e.g., illuminance values for each segment, on/off status, nighttime mode, etc.) from illuminance sensors and smart lighting control systems installed inside the building and stores it in a lighting information database. The navigation unit inputs the user's current location vector, destination vector, lighting information database, and user visual characteristic profile (e.g., elderly, visually impaired, etc.) into a route generation AI module. The route generation AI uses graph neural networks and illuminance optimization algorithms to calculate illuminance scores for each route segment (e.g., brightness 0.95, darkness 0.2, etc.) and automatically selects the route with the highest overall illuminance or a route that avoids dark segments. Examples of AI input include: (1) illuminance vectors (e.g., illuminance values for each segment); (2) current location and destination vectors; (3) user visual characteristic labels (e.g., visually impaired, elderly); (4) building route graph structure data. AI outputs include: (1) illuminance-optimized route node sequence (e.g., route via bright segments); (2) illuminance scores for each route segment; (3) guidance text sequence. Output examples include: (1) “Guide route via bright areas avoiding dark areas”; (2) “Prioritize route with sufficient lighting at night”; (3) “Emphasize bright segments if user feels visually uneasy.” Based on these AI outputs, the navigation unit emphasizes illuminance information in the user interface and voice guidance unit, enhancing the user's sense of security and safety. Furthermore, if lighting conditions change, the AI model performs re-inference and instantly recalculates the route. Unlike conventional uniform route guidance or subjective illuminance judgment by humans, the navigation unit combines IoT lighting data and AI illuminance optimization technology to realize a guidance experience that responds instantly to the user's safety and peace of mind. Technical effects include reduced risk of falls and anxiety, improved accessibility for nighttime and visually impaired users, and increased user satisfaction. Application fields include building navigation terminals, patient guidance in medical institutions, barrier-free support, and safe route guidance in nighttime facilities.

The provision unit can provide additional information about the destination when the user arrives at the destination. For example, when the user arrives at a meeting room, the provision unit can notify the meeting start time and the list of participants. When the user arrives at a store, the provision unit can notify the store's business hours and special offers. Furthermore, when the user arrives at a tourist spot, the provision unit can notify the history and highlights of the tourist spot. Thus, the user can obtain useful information even after arriving at the destination. Specifically, the provision unit uses the destination arrival event as a trigger to input the user profile, destination attribute vector (e.g., building_id=123, floor=3, room=305, category=meeting room/store/tourist spot, etc.), and related information database (e.g., meeting schedule, store information, tourist spot explanation, etc.) into an information generation AI module. The information generation AI uses large language models and knowledge graph inference engines to automatically generate optimal additional information text (e.g., “The meeting starts at 10:00, participants are A, B, and C,” “Today's special offer is 10% off,” “This tourist spot was built in the Edo period,” etc.) according to the destination attributes and user attributes. Examples of AI input include: (1) destination attribute vector; (2) user profile (e.g., position, areas of interest); (3) related information database (e.g., meeting schedule, store offers, tourist spot explanation). AI outputs include: (1) additional information text; (2) notification priority score; (3) display layout parameters. Output examples include: (1) “Notify meeting start time and participant list”; (2) “Notify store business hours and special offers”; (3) “Notify history and highlights of tourist spot.” Based on these AI outputs, the provision unit instantly displays and notifies additional information via the user interface and voice guidance unit, supporting the user's actions and decision-making. Furthermore, if the user's destination or areas of interest change, the AI model performs re-inference and instantly regenerates the additional information content. Unlike conventional static information display or manual notification by humans, the provision unit combines dynamic information generation by AI and personalized control to greatly improve user convenience and satisfaction. Application fields include building navigation terminals, guidance systems for commercial facilities, tourist guides, patient guidance in medical institutions, and participant guidance at event venues.

The reception unit can estimate the user's emotion and propose destinations based on the estimated emotion. For example, if the user is feeling stressed, the reception unit can propose relaxing cafes or parks. If the user is excited, the reception unit can propose entertainment facilities or activities. Furthermore, if the user is tired, the reception unit can propose nearby rest spots or massage facilities. Thus, the user can select the optimal destination according to their emotion. Specifically, the reception unit inputs facial image tensors obtained from the user terminal's camera (e.g., 224×224 pixel RGB images), voice waveform data (e.g., 1 second of audio), and touch operation logs (e.g., input speed, tap intervals, etc.) into an emotion estimation AI module. The emotion estimation AI extracts facial features using convolutional neural networks, analyzes voice tone and speech rate using recurrent neural networks for voice recognition, and analyzes behavioral patterns using time-series models. Examples of AI input include: (1) facial image tensors (e.g., expressions of stress, excitement, fatigue); (2) voice waveforms (e.g., utterances such as “I'm tired,” “I'm looking forward to it”); (3) touch operation logs (e.g., consecutive taps, long presses). AI outputs include: (1) emotion labels (e.g., stress, excitement, fatigue); (2) emotion intensity scores (e.g., stress level 0.8); (3) recommended destination list (e.g., cafe, entertainment facility, rest spot). Output examples include: (1) “Propose cafes or parks due to stress state”; (2) “Propose entertainment facilities due to excitement state”; (3) “Propose rest spots due to fatigue state.” Based on these AI outputs, the reception unit dynamically displays the destination candidate list on the user interface and highlights candidates tailored to the user's emotional state. Furthermore, if the emotional state changes, the AI model performs re-inference and instantly updates the candidate list. Unlike conventional uniform destination proposals or subjective judgment by humans, the reception unit combines multimodal emotion estimation and candidate optimization to realize a destination selection experience that responds instantly to the user's psychological state. Technical effects include improved efficiency in destination selection, increased user satisfaction, and reduced misselection. Application fields include building navigation reception terminals, guidance systems for public facilities, reception support in medical institutions, and optimization of barrier-free interfaces.

The reception unit can analyze the user's past destination input history and propose the optimal input method based on the user's emotion. For example, if the user was stressed in the past, the reception unit can provide a simple interface. If the user was relaxed in the past, the reception unit can provide detailed input options. Furthermore, if the user was in a hurry in the past, the reception unit can preferentially propose voice input. Thus, the user can select the optimal input method according to their emotion. Specifically, the reception unit inputs a destination input history database recorded for each user in chronological order (e.g., input method for the past 30 times, input time, required input time, estimated emotional state, etc.) into an analysis AI module. The analysis AI extracts the user's input tendencies and input method preferences for each emotional state using time-series clustering algorithms or autoregressive neural networks. Examples of AI input include: (1) input method labels for the past 30 times (e.g., text, voice, touch); (2) input time vectors; (3) required input time scalar values; (4) emotional state labels (e.g., stress, relaxation, hurry). AI outputs include: (1) recommended input method list (e.g., simple UI for stress, detailed UI for relaxation, voice input for hurry); (2) optimal input method for each emotional state; (3) predicted input efficiency score. Output examples include: (1) “Recommend simple interface for stress”; (2) “Recommend detailed input options for relaxation”; (3) “Preferentially propose voice input for hurry.” Based on these AI outputs, the reception unit dynamically switches the layout and input method of the user interface to provide the optimal input experience tailored to the user's emotional state and history. Furthermore, as new input history is accumulated for the user, the AI model continuously improves personalization accuracy through online learning. Unlike conventional static input methods or uniform UI presentation, the reception unit combines history pattern analysis and emotion-adaptive UI control to greatly improve input efficiency and user satisfaction. Application fields include building navigation reception terminals, guidance systems for public facilities, reception support in medical institutions, and optimization of barrier-free interfaces.

The reception unit can estimate the user's emotion based on the user's current situation and areas of interest, and present input candidates according to the estimated emotion. For example, the reception unit can propose relaxing spots near the user's current location. If the user is excited, the reception unit can propose entertainment facilities. Furthermore, if the user is tired, the reception unit can propose nearby rest spots. Thus, the user can select the optimal input candidate according to their emotion. Specifically, the reception unit inputs the current location vector obtained from the user terminal (e.g., x=35.6895, y=139.6917, floor=3), areas of interest vector (e.g., cafe=0.8, entertainment=0.6, etc.), and emotion label from the emotion estimation AI module (e.g., relaxation, excitement, fatigue) into a candidate generation AI module. The candidate generation AI uses graph neural networks and interest score algorithms to generate a candidate list based on current location, areas of interest, and emotional state. Examples of AI input include: (1) current location vector; (2) areas of interest vector; (3) emotion label; (4) spot information vector (e.g., coordinates and categories of each spot). AI outputs include: (1) candidate list optimized for emotion and interest (e.g., cafe for relaxation, entertainment facility for excitement, rest spot for fatigue); (2) recommendation score for each candidate; (3) explanation text for each candidate. Output examples include: (1) “Propose relaxing spot near current location”; (2) “Propose entertainment facility due to excitement state”; (3) “Propose rest spot due to fatigue state.” Based on these AI outputs, the reception unit dynamically displays the candidate list on the user interface and highlights candidates tailored to the user's situation and interests. Furthermore, if the situation or areas of interest change, the AI model performs re-inference and instantly updates the candidate list. Unlike conventional uniform candidate presentation or subjective judgment by humans, the reception unit combines multidimensional situation data and emotion estimation AI to realize an optimal input experience that responds instantly to the user's usage situation and psychological state. Technical effects include improved efficiency in destination selection, increased user satisfaction, and reduced misselection. Application fields include building navigation reception terminals, guidance systems for public facilities, reception support in medical institutions, and optimization of barrier-free interfaces.

The reception unit can estimate the user's emotion and determine the priority of input candidates based on the estimated emotion. For example, if the user is tired, the reception unit can preferentially present nearby rest spots. If the user is excited, the reception unit can preferentially present entertainment facilities. Furthermore, if the user is relaxed, the reception unit can preferentially present places where the user can relax, such as cafes or parks. As a result, the user can select the optimal input candidate according to their own emotional state. Specifically, the reception unit inputs a facial image tensor obtained from the user's terminal camera (e.g., 224×224 pixel RGB image), voice waveform data (e.g., 1 second of audio), and touch operation logs (e.g., input speed, tap intervals, etc.) into an emotion estimation AI module. The emotion estimation AI extracts facial features using a convolutional neural network, analyzes voice tone and speech rate using a recurrent neural network for voice recognition, and analyzes behavioral patterns using a time-series model. Examples of inputs to the AI include: (1) facial image tensor (e.g., expressions of fatigue, excitement, relaxation), (2) voice waveform (e.g., utterances such as “I'm tired,” “I'm looking forward to it”), and (3) touch operation logs (e.g., continuous tapping, long press, etc.). The AI outputs: (1) emotion labels (e.g., fatigue, excitement, relaxation), (2) emotion intensity scores (e.g., fatigue level 0.9), and (3) input candidate priority lists (e.g., rest spot ranked first, entertainment ranked second, cafe ranked third). Examples of outputs include: (1) “Display rest spots at the top due to high fatigue level,” (2) “Prioritize entertainment facilities due to excitement,” and (3) “Display cafes and parks at the top due to relaxation.” Based on these AI outputs, the reception unit dynamically adjusts the order of the candidate list on the user interface and highlights candidates that match the user's emotional state. Furthermore, if the emotional state changes, the AI model performs re-inference and immediately updates the candidate ranking. Unlike conventional uniform candidate presentation, the reception unit combines multimodal emotion estimation and candidate priority optimization to provide an input experience that responds to the user's psychological state. Technical effects include improved efficiency in destination selection, increased user satisfaction, and reduced erroneous selections. Applicable fields include building navigation reception terminals, public facility guidance systems, reception support in medical institutions, and optimization of barrier-free interfaces.

The generation unit can estimate the user's emotion and adjust the route calculation method based on the estimated emotion. For example, if the user is relaxed, the generation unit can prioritize and calculate scenic routes. If the user is in a hurry, the generation unit can prioritize and calculate the shortest route. Furthermore, if the user is excited, the generation unit can prioritize and calculate routes with many activities. As a result, the user can reach the destination via the optimal route according to their own emotional state. Specifically, the generation unit inputs emotion estimation data received from the reception unit or navigation unit (e.g., emotion label “relaxed,” “in a hurry,” “excited,” emotion intensity score 0.85, etc.), the user's current location vector (e.g., x=35.6895, y=139.6917, floor=2), and destination attribute vector (e.g., building_id=123, floor=3, room=305) into a route generation AI module. The route generation AI uses a hybrid model that incorporates graph neural networks and reinforcement learning algorithms, dynamically reflecting emotional state as parameters in the route cost function or reward function. Examples of inputs to the AI include: (1) emotion label (e.g., relaxed), (2) emotion intensity score (e.g., 0.7), (3) current location and destination vectors, and (4) building route graph structure data. The AI outputs: (1) a sequence of route nodes optimized for the emotional state (e.g., route including scenic corridors, shortest distance route, activity-rich route), (2) a sequence of guidance texts for each route segment (e.g., “Take the elevator to the third floor, there is a cafe on your right”), and (3) recommendation scores for each route. Examples of outputs include: (1) “Recommend scenic route due to relaxed state,” (2) “Present shortest route due to hurry,” and (3) “Guide to activity-rich route due to excitement.” Based on these AI outputs, the generation unit sends optimized route information to the user interface or navigation unit, realizing route guidance that responds to the user's emotional state. Furthermore, if the user's emotional state changes, the AI model performs re-inference and immediately recalculates the route. Unlike conventional uniform route calculation or subjective human judgment, the generation unit incorporates emotion parameters into high-dimensional route optimization algorithms, greatly improving guidance accuracy and personalization of the user experience. Technical effects include flexible route guidance that responds to the user's psychological state and usage scene, increased travel satisfaction, and reduced erroneous guidance. Applicable fields include building navigation, commercial facility guidance, tourist site guides, patient guidance in medical institutions, and barrier-free support.

The following is a brief explanation of the processing flow of Example of the Embodiment. Specifically, the system operates in cooperation with multiple functional modules such as the reception unit, generation unit, navigation unit, and provision unit. The reception unit receives destination input from the user, preprocesses input data (e.g., text, voice, touch operations, etc.), and analyzes the user's state in cooperation with the user profile and emotion estimation AI module. The generation unit calculates the optimal route using the route generation AI module based on destination information and user state data received from the reception unit. The navigation unit, based on route information received from the generation unit, cooperates with building floor guides and real-time environmental information (e.g., congestion level, lighting, temperature, etc.) to provide detailed guidance displays and voice guidance. The provision unit detects user arrival events and changes in status, generates and sends additional information and notifications according to the destination. Each unit's AI module receives multidimensional vectors such as user emotion, status, history, and environmental data as input, and performs inference and optimization using neural networks and reinforcement learning algorithms. Examples of inputs to the AI include: (1) facial image tensor, (2) voice waveform, (3) touch operation log, (4) current location vector, (5) past history vector, and (6) environmental sensor data. The AI outputs: (1) emotion label, (2) candidate list with recommendation scores, (3) route node sequence, (4) guidance text, and (5) notification content. Examples of outputs include “Display rest spots at the top due to high fatigue level,” “Present shortest route due to hurry,” and “Notify meeting information upon arrival at destination.” Each unit dynamically optimizes the user interface, notification means, and guidance content based on AI outputs, realizing personalized guidance experiences that respond to the user's situation and emotion. Unlike conventional static guidance systems or subjective human judgment, the system demonstrates technical effects of greatly improving guidance accuracy, efficiency, and satisfaction through multidimensional data integration and AI optimization technology. Applicable fields include building navigation, commercial facility guidance, tourist site guides, patient guidance in medical institutions, barrier-free support, and route guidance at event venues.

Step 1: The reception unit receives input of a destination from the user. For example, the reception unit can receive destination input via text input, voice input, or touch input. Step 2: The generation unit calculates a route from the current location to the destination based on information received by the reception unit. For example, the generation unit obtains the current location using GPS, Wi-Fi location information, or beacons, and calculates the route using algorithms such as shortest distance, shortest time, or congestion avoidance. Step 3: The navigation unit displays a detailed route in cooperation with building and floor guides based on the route generated by the generation unit. For example, the navigation unit displays floor guides inside the building and indicates the locations of elevators and stairs. Furthermore, the navigation unit displays a detailed route to the destination based on the floor guide. As a result, the user can reach the destination without wandering inside the building. Specifically, in Step 1, the reception unit receives input data from the user's terminal (e.g., text “Conference Room 305,” voice “Cafe on the third floor,” spot selection via touch panel, etc.), and performs preprocessing for each input method (e.g., voice recognition, text normalization, candidate spot matching, etc.). The reception unit analyzes the user's state (e.g., fatigue, hurry, relaxation, etc.) in cooperation with the user profile, past history, and emotion estimation AI module. In Step 2, the generation unit inputs destination information received from the reception unit, current location vector (e.g., x=35.6895, y=139.6917, floor=2), building route graph structure data, congestion and environmental sensor data, etc., into the route generation AI module, and calculates the optimal route using graph neural networks and reinforcement learning algorithms. Examples of inputs to the AI include: (1) destination vector, (2) current location vector, (3) congestion map, and (4) environmental comfort vector. The AI outputs: (1) route node sequence (e.g., entrance→elevator→third floor→Conference Room 305), (2) guidance text sequence (e.g., “Take the elevator to the third floor”), and (3) recommendation score. In Step 3, the navigation unit, based on route information received from the generation unit, cooperates with building floor guide images and real-time environmental information to display the route and provide voice guidance on the user interface. For example, it highlights the locations of elevators and stairs, and displays congestion sections and comfort information using color coding. Furthermore, if the user's movement or emotional state changes, the AI model performs re-inference and immediately recalculates and redisplays the route and guidance content. Unlike conventional static guidance displays or subjective human judgment, the system demonstrates technical effects of greatly improving guidance accuracy, efficiency, and satisfaction through multidimensional data integration and AI optimization technology. Applicable fields include building navigation, commercial facility guidance, tourist site guides, patient guidance in medical institutions, barrier-free support, and route guidance at event venues.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the aforementioned elements, including the reception unit, generation unit, navigation unit, and provision unit, is implemented by at least one of, for example, a smart device 14 and a data processing apparatus 12. For example, the reception unit receives the user's destination input using a touch panel 38A or a microphone 38B of the smart device 14. The generation unit is implemented by a specific processing unit 290 of the data processing apparatus 12 and calculates a route using GPS or Wi-Fi location information. The navigation unit displays a floor guide inside the building and a detailed route using a display 40A of the smart device 14. The provision unit sends a notification to the user using a speaker 40B of the smart device 14. The correspondence between each unit and the device or control unit is not limited to the examples described above and various modifications are possible.

### Second Embodiment

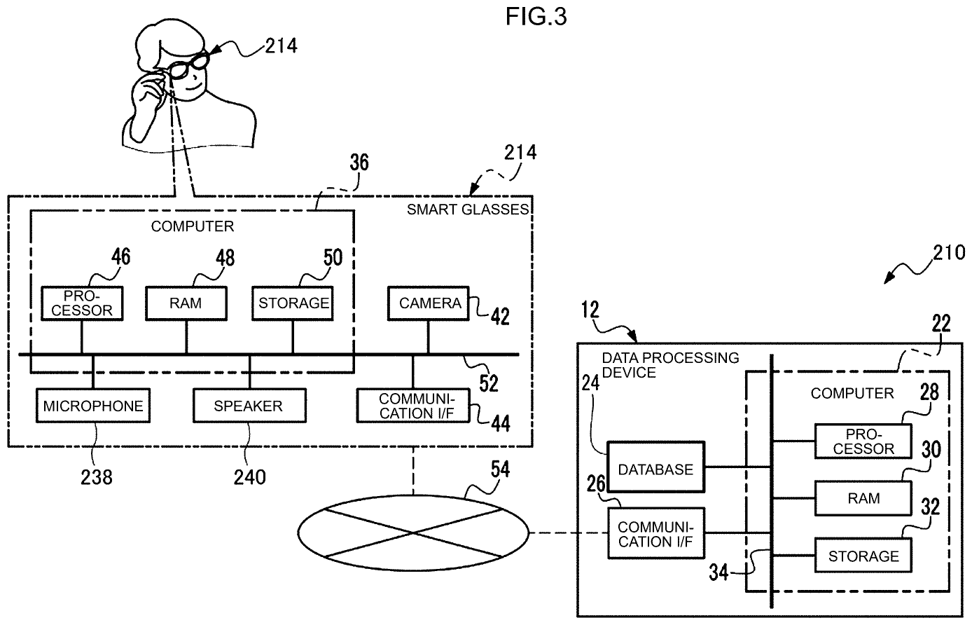

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

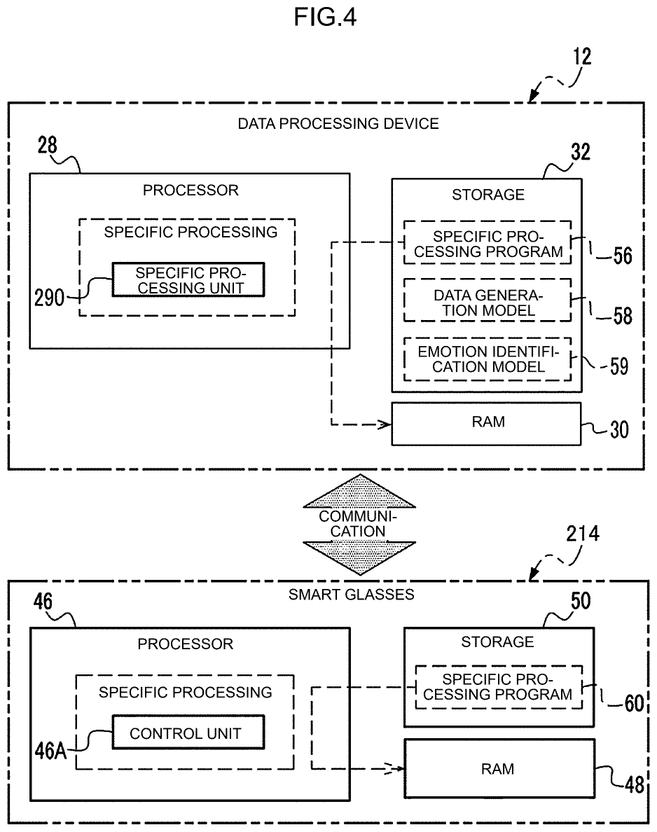

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the aforementioned elements, including the reception unit, generation unit, navigation unit, and provision unit, is implemented by at least one of, for example, smart glasses 214 and a data processing apparatus 12. For example, the reception unit receives the user's destination input using a microphone 238 of the smart glasses 214. The generation unit is implemented by a specific processing unit 290 of the data processing apparatus 12 and calculates a route using GPS or Wi-Fi location information. The navigation unit displays a floor guide inside the building and a detailed route using a display of the smart glasses 214. The provision unit sends a notification to the user using a speaker 240 of the smart glasses 214. The correspondence between each unit and the device or control unit is not limited to the examples described above and various modifications are possible.

### Third Embodiment

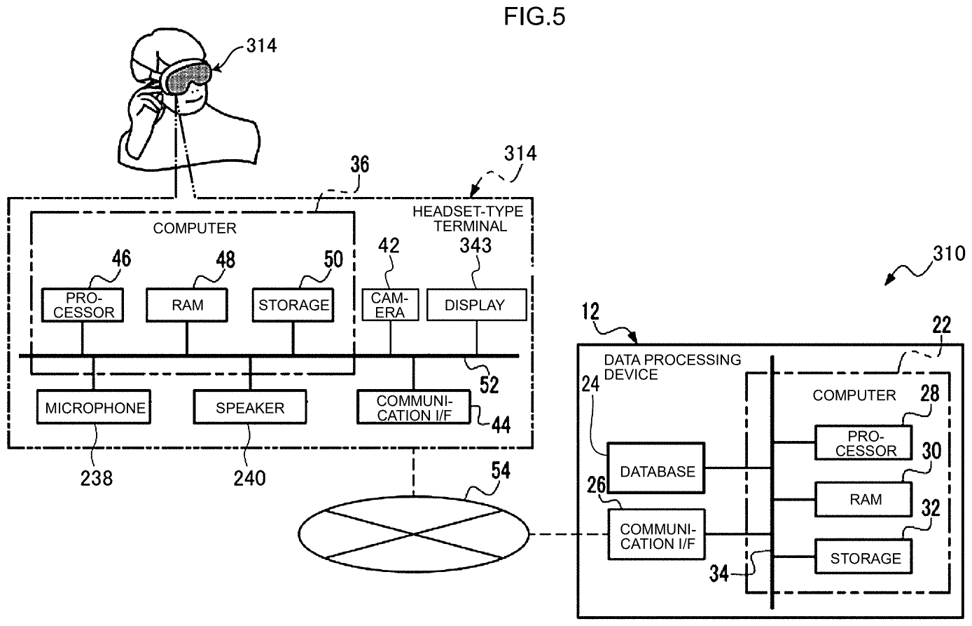

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

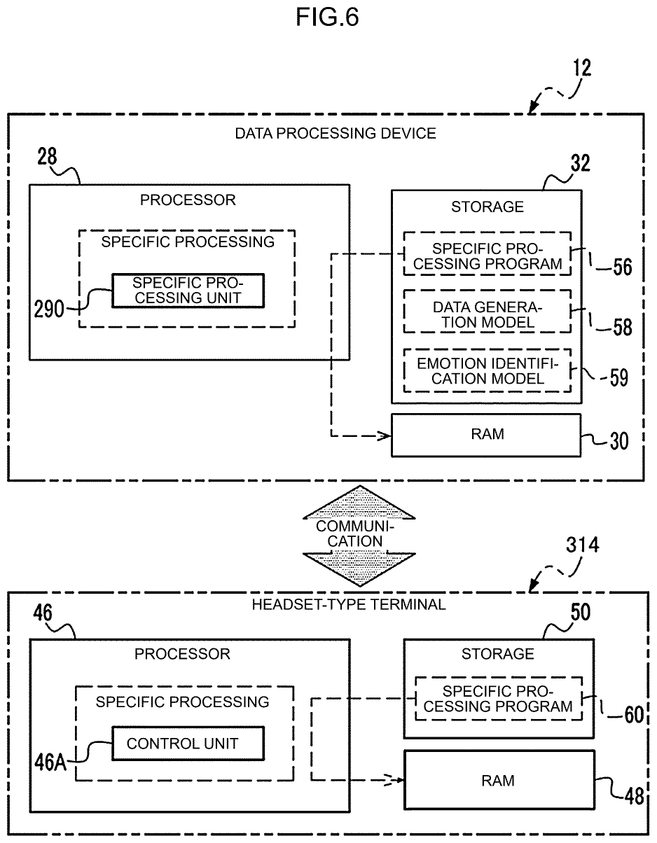

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the aforementioned elements, including the reception unit, generation unit, navigation unit, and provision unit, is implemented by at least one of, for example, a headset-type terminal 314 and a data processing apparatus 12. For example, the reception unit receives the user's destination input using a microphone 238 of the headset-type terminal 314. The generation unit is implemented by a specific processing unit 290 of the data processing apparatus 12 and calculates a route using GPS or Wi-Fi location information. The navigation unit displays a floor guide inside the building and a detailed route using a display 343 of the headset-type terminal 314. The provision unit sends a notification to the user using a speaker 240 of the headset-type terminal 314. The correspondence between each unit and the device or control unit is not limited to the examples described above and various modifications are possible.

### Fourth Embodiment

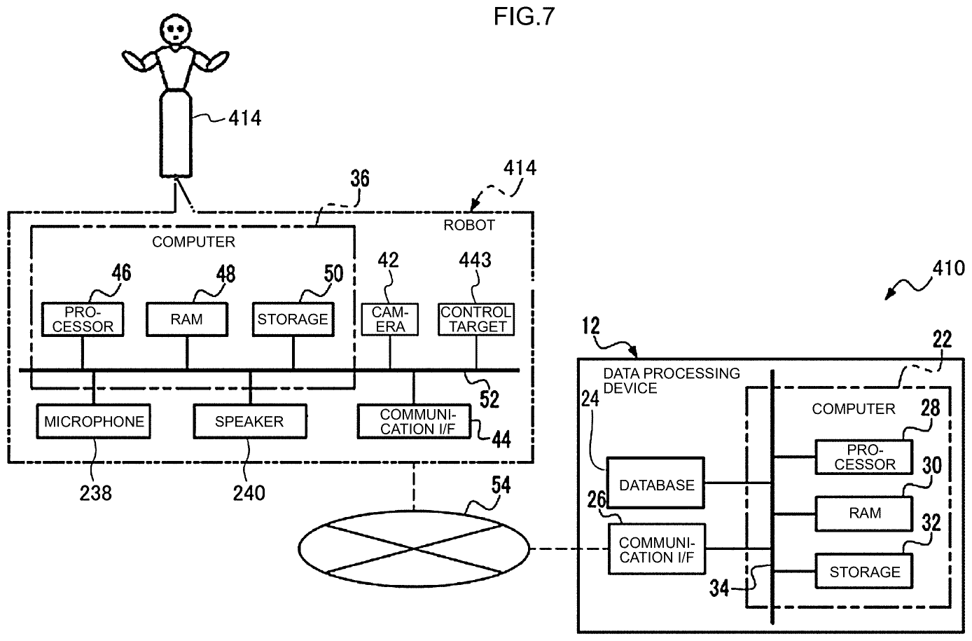

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

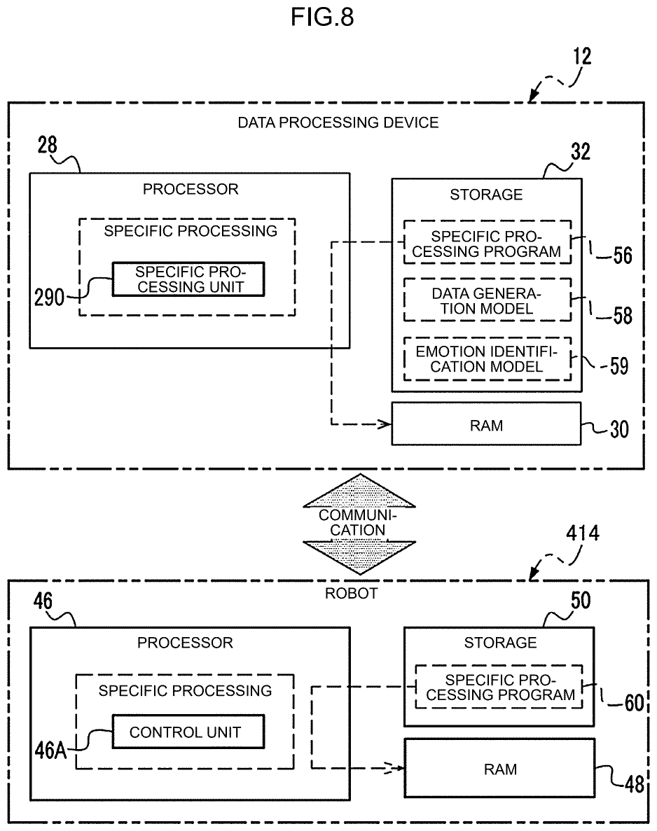

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the aforementioned elements, including the reception unit, generation unit, navigation unit, and provision unit, is implemented by at least one of, for example, a robot 414 and a data processing apparatus 12. For example, the reception unit receives the user's destination input using a microphone 238 of the robot 414. The generation unit is implemented by a specific processing unit 290 of the data processing apparatus 12 and calculates a route using GPS or Wi-Fi location information. The navigation unit displays a floor guide inside the building and a detailed route using a display of the robot 414. The provision unit sends a notification to the user using a speaker 240 of the robot 414. The correspondence between each unit and the device or control unit is not limited to the examples described above and various modifications are possible.

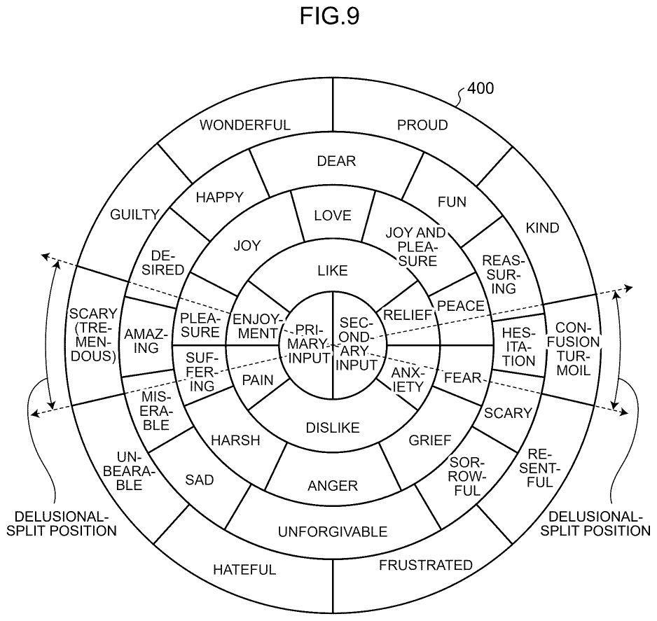

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

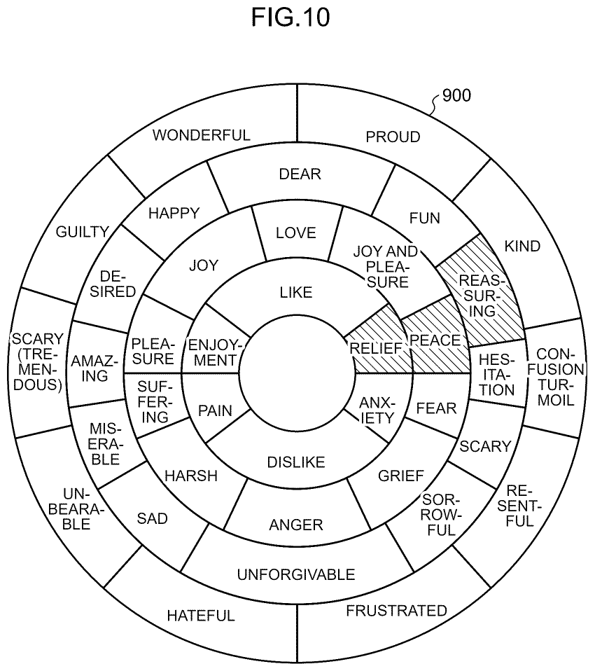

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to receive input of a destination; a generation unit configured to calculate a route from a current location to the destination based on information received by the reception unit; and a navigation unit configured to display the route in cooperation with building and floor guides based on the route generated by the generation unit.
(Supplementary Note 2) The system according to Supplementary Note 1, wherein the navigation unit tracks the user's position in real time and dynamically updates the route.
(Supplementary Note 3) The system according to Supplementary Note 1, wherein the navigation unit grasps congestion conditions inside the building and proposes a route that avoids congestion.
(Supplementary Note 4) The system according to Supplementary Note 1, wherein the navigation unit displays floor guide information and indicates the locations of elevators and stairs.
(Supplementary Note 5) The system according to Supplementary Note 1, further comprising a provision unit, wherein the provision unit sends a notification when the user reaches the destination.
(Supplementary Note 6) The system according to Supplementary Note 1, wherein the reception unit estimates the user's emotion and adjusts the method of destination input based on the estimated emotion.
(Supplementary Note 7) The system according to Supplementary Note 1, wherein the reception unit analyzes the user's past destination input history and proposes an optimal input method.
(Supplementary Note 8) The system according to Supplementary Note 1, wherein the reception unit presents input candidates based on the user's current situation and areas of interest when inputting a destination.
(Supplementary Note 9) The system according to Supplementary Note 1, wherein the reception unit estimates the user's emotion and determines the priority of input candidates based on the estimated emotion.
(Supplementary Note 10) The system according to Supplementary Note 1, wherein the reception unit preferentially presents highly relevant candidates by considering the user's geographic location information when inputting a destination.
(Supplementary Note 11) The system according to Supplementary Note 1, wherein the reception unit analyzes the user's social media activity when inputting a destination and presents relevant candidates.
(Supplementary Note 12) The system according to Supplementary Note 1, wherein the generation unit estimates the user's emotion and adjusts the route calculation method based on the estimated emotion.
(Supplementary Note 13) The system according to Supplementary Note 1, wherein the generation unit adjusts the level of detail of the route based on the importance of the destination when generating the route.
(Supplementary Note 14) The system according to Supplementary Note 1, wherein the generation unit applies different route calculation algorithms according to the category of the destination when generating the route.
(Supplementary Note 15) The system according to Supplementary Note 1, wherein the generation unit estimates the user's emotion and adjusts the length of the route based on the estimated emotion.
(Supplementary Note 16) The system according to Supplementary Note 1, wherein the generation unit determines the priority of the route based on the submission timing of the destination when generating the route.
(Supplementary Note 17) The system according to Supplementary Note 1, wherein the generation unit adjusts the order of the route based on the relevance of the destination when generating the route.
(Supplementary Note 18) The system according to Supplementary Note 1, wherein the navigation unit estimates the user's emotion and adjusts the display method of navigation based on the estimated emotion.
(Supplementary Note 19) The system according to Supplementary Note 1, wherein the navigation unit refers to the user's past movement history during navigation and selects an optimal navigation method.
(Supplementary Note 20) The system according to Supplementary Note 1, wherein the navigation unit refers to the user's past movement history during navigation and selects an optimal navigation method.
(Supplementary Note 21) The system according to Supplementary Note 1, wherein the navigation unit customizes the means of navigation based on the user's current situation during navigation.
(Supplementary Note 22) The system according to Supplementary Note 1, wherein the navigation unit estimates the user's emotion and determines the priority of navigation based on the estimated emotion.
(Supplementary Note 23) The system according to Supplementary Note 1, wherein the navigation unit considers the user's geographic location information during navigation and selects an optimal navigation method.
(Supplementary Note 24) The system according to Supplementary Note 1, wherein the navigation unit analyzes the user's social media activity during navigation and proposes means of navigation.
(Supplementary Note 25) The system according to Supplementary Note 1, wherein the provision unit estimates the user's emotion and adjusts the content of the notification based on the estimated emotion.
(Supplementary Note 26) The system according to Supplementary Note 1, wherein the provision unit refers to the user's past notification history when sending a notification and selects an optimal notification method.
(Supplementary Note 27) The system according to Supplementary Note 1, wherein the provision unit adjusts the content of the notification based on the user's current situation when sending a notification.
(Supplementary Note 28) The system according to Supplementary Note 1, wherein the provision unit estimates the user's emotion and determines the priority of notifications based on the estimated emotion.
(Supplementary Note 29) The system according to Supplementary Note 1, wherein the provision unit considers the user's device information when sending a notification and selects an optimal notification method.

What is claimed is:

1. A system comprising:
circuitry configured to:
receive, from a client terminal via a packet-switched network, input data indicating a target location identifier;
generate node sequence data representing a path from a current location to the target location identifier by inputting current location vector data and the target location identifier into a route generation model based on a graph neural network, the route generation model computing an optimal traversal over a graph structure comprising nodes and edges; and
transmit, to the client terminal via the packet-switched network, display data comprising the node sequence data and spatial layout data associated with the graph structure for rendering on the client terminal.

2. The system according to claim 1, wherein the circuitry is further configured to:
receive, from the client terminal via the packet-switched network, location update data comprising at least one of a global positioning system coordinate vector, a wireless access point trilateration vector, and acceleration sensor values; and
re-input the location update data into the route generation model to dynamically recalculate the node sequence data.

3. The system according to claim 1, wherein the circuitry is further configured to:
receive congestion data comprising at least one of infrared sensor count values, carbon dioxide concentration values, and surveillance image data associated with the nodes of the graph structure;
compute a congestion score for each node by inputting the congestion data into a congestion estimation model comprising a convolutional neural network; and
adjust the optimal traversal based on the congestion score for each node.

4. The system according to claim 1, wherein the display data further comprises overlay image data generated by inputting the node sequence data and equipment coordinate data indicating locations of vertical transport elements into a layout generation model, the overlay image data indicating positions of the vertical transport elements relative to the path.

5. The system according to claim 1, wherein the circuitry is further configured to:
receive, from the client terminal via the packet-switched network, updated position data;
determine an arrival state by computing a distance between the updated position data and the target location identifier; and
transmit, to the client terminal via the packet-switched network, a notification signal when the arrival state satisfies a threshold condition.

6. The system according to claim 1, wherein the circuitry is further configured to:
receive, from the client terminal via the packet-switched network, multimodal sensor data comprising at least one of facial image tensor data, voice waveform data, and behavioral log vector data;
generate an emotion label and an emotion intensity score by inputting the multimodal sensor data into an emotion estimation model comprising a convolutional neural network and a recurrent neural network; and
select an input interface mode for the client terminal based on the emotion label.

7. The system according to claim 1, wherein the circuitry is further configured to:
access a history database comprising input method labels, input timestamps, and required input time values recorded in chronological order for a user associated with the client terminal; and
generate a recommended input method by inputting the history database into an analysis model based on an autoregressive neural network.

8. The system according to claim 1, wherein the circuitry is further configured to:
receive, from the client terminal via the packet-switched network, context data comprising the current location vector data and an interest score vector; and
generate a ranked candidate list of target location identifiers by inputting the context data and a location information database into a candidate generation model based on a graph neural network, each candidate being associated with a relevance score.

9. The system according to claim 6, wherein the circuitry is further configured to:
generate a priority-ordered candidate list of target location identifiers based on the emotion label, such that a ranking of candidates in the priority-ordered candidate list varies according to the emotion label.

10. The system according to claim 1, wherein the circuitry is further configured to:
compute a distance metric between the current location vector data and each of a plurality of candidate location identifiers stored in a location information database;
generate a sorted candidate list based on the distance metric and a visit history vector associated with a user of the client terminal; and
transmit the sorted candidate list to the client terminal via the packet-switched network.

11. The system according to claim 6, wherein the circuitry is further configured to:
modify a cost function of the route generation model based on the emotion label and the emotion intensity score, such that the node sequence data varies according to the emotion label.

12. The system according to claim 1, wherein the circuitry is further configured to:
receive an importance score and a category label associated with the target location identifier; and
adjust a detail level parameter of the route generation model based on the importance score, such that the node sequence data includes a greater number of intermediate nodes when the importance score exceeds a predetermined value.

13. The system according to claim 1, wherein the circuitry is further configured to:
determine a category label associated with the target location identifier; and
select a route calculation algorithm from a plurality of route calculation algorithms based on the category label, the plurality of route calculation algorithms comprising at least a shortest-distance algorithm and a congestion-avoidance algorithm.

14. The system according to claim 1, wherein the circuitry is further configured to:
access a movement history database comprising node sequences, movement timestamps, and congestion level values recorded for a user associated with the client terminal; and
generate a route recommendation by inputting the movement history database into an analysis model based on a time-series clustering algorithm, the route recommendation identifying frequently used paths and congestion avoidance patterns.

15. The system according to claim 1, wherein the circuitry is further configured to:
receive, from the client terminal via the packet-switched network, movement determination data comprising time-series acceleration values, gyro sensor values, and speed vector data; and
classify a movement mode of a user of the client terminal by inputting the movement determination data into a movement classification model comprising a convolutional neural network and a long short-term memory network, the movement mode being one of walking, driving, and public transportation.

16. The system according to claim 1, wherein the circuitry is further configured to:
receive environmental sensor data comprising at least one of temperature values, humidity values, and air quality values associated with segments of the graph structure; and
compute a comfort score for each segment by inputting the environmental sensor data into an environmental evaluation model, and adjust the optimal traversal to prioritize segments having comfort scores exceeding a comfort threshold.

17. The system according to claim 5, wherein the circuitry is further configured to:
generate additional information text associated with the target location identifier by inputting a destination attribute vector and a user profile into an information generation model comprising a large language model; and
transmit the additional information text to the client terminal via the packet-switched network concurrently with the notification signal.

18. A system comprising:
a communication interface configured to communicate with a client terminal via a packet-switched network;
a memory storing a route generation model obtained by deep learning on a graph neural network and an emotion estimation model obtained by deep learning on a neural network;
a processor coupled to the communication interface and the memory, the processor being configured to:
receive, from the client terminal via the communication interface, input data indicating a target location identifier and multimodal sensor data comprising facial image tensor data and voice waveform data;
generate an emotion label by inputting the multimodal sensor data into the emotion estimation model;
generate node sequence data representing a path from a current location to the target location identifier by inputting current location vector data, the target location identifier, and the emotion label into the route generation model, the route generation model computing an optimal traversal over a graph structure comprising nodes and edges with a cost function modified based on the emotion label; and
transmit, to the client terminal via the communication interface, display data comprising the node sequence data and spatial layout data associated with the graph structure.

19. The system according to claim 18, wherein the processor is further configured to:
receive, from the client terminal via the communication interface, location update data at periodic intervals;
re-input the location update data into the route generation model to dynamically recalculate the node sequence data; and
transmit updated display data to the client terminal via the communication interface in response to each recalculation.

20. A method performed by a system comprising circuitry, the method comprising:
receiving, from a client terminal via a packet-switched network, input data indicating a target location identifier;
generating node sequence data representing a path from a current location to the target location identifier by inputting current location vector data and the target location identifier into a route generation model based on a graph neural network, the route generation model computing an optimal traversal over a graph structure comprising nodes and edges; and
transmitting, to the client terminal via the packet-switched network, display data comprising the node sequence data and spatial layout data associated with the graph structure for rendering on the client terminal.
